(19) United States
(12) Patent Application Publication
(10) Pub. No.: US 2024/0408864 A1
(43) Pub. Date: Dec. 12, 2024

(54) INK JET RECORDING METHOD AND INK JET RECORDING APPARATUS

(71) Applicant: CANON KABUSHIKI KAISHA, Tokyo (JP)

(72) Inventors: TAKASHI SAITO, Kanagawa (JP); KOUHEI NAKAGAWA, Tokyo (JP)

(21) Appl. No.: 18/739,809

(22) Filed: Jun. 11, 2024

(30) Foreign Application Priority Data
Jun. 12, 2023 (JP) 2023-096383
May 15, 2024 (JP) 2024-079385

(51) Int. Cl. B41J 2/045; B41J 2/15; C09D 11/322; C09D 11/38

(52) U.S. Cl. CPC B41J 2/04523; B41J 2/0458; B41J 2/15; C09D 11/322; C09D 11/38

(57) ABSTRACT

Provided is an ink jet recording method capable of recording a high-quality image in which a positional shift between ruled lines recorded with a plurality of inks through use of a circulation serial head and variations in their line widths are reduced. The ink jet recording method includes recording an image by ejecting an ink from a recording head including, an ejection element and a first flow path and a second flow path. This method includes an ejection step and a flow step. The recording head is of a serial type. The first flow path and the second flow path are arranged in parallel to a scanning direction and have the same flow direction of the ink. Ejection orifice arrays include a first ejection orifice array. A static surface tension γs₁ of the first ink and a static surface tension γs₂ of the second ink satisfy a relationship of γs₁<γs₂.

### BACKGROUND OF THE INVENTION

### Field of the Invention

The present invention relates to an ink jet recording method and an ink jet recording apparatus.

### Description of the Related Art

With an ink jet recording method, images, such as photographs and documents, can be recorded on various recording mediums. In addition, there have been proposed various inks in accordance with applications, such as an ink suitable for recording an image of photographic quality on glossy paper and an ink suitable for recording a document or the like on plain paper.

In recent years, the ink jet recording method has been utilized in the case of recording a business document including a character and a diagram on a recording medium such as plain paper, and the frequency of utilization in such applications has been remarkably increased. Moreover, the ink jet recording method has been required to be capable of recording the document at a higher speed than ever before. In addition, there is also a strong need for downsizing of an ink jet recording apparatus because of, for example, limitations on its installation place.

As the type of a recording head of the ink jet recording apparatus, there are two kinds: a serial type and a line type. From the viewpoint of downsizing, a recording head of a serial type (serial head) is advantageous. In order to increase a recording speed through use of the serial head, an increase in scanning speed of the recording head is required. In addition, it is required to reduce the frequency of a so-called preliminary ejection operation, which is one kind of recovery treatment performed during scanning of the recording head, or to perform single pass recording in which a plurality of inks is applied to a unit region by single relative scanning between the recording head and a recording medium.

As a method of reducing the frequency of the preliminary ejection operation, for example, there has been proposed a liquid ejection head capable of preventing a solid content in a liquid from staying around a peripheral edge of an ejection orifice even after an ejection operation is paused for a predetermined time period (Japanese Patent Application Laid-Open No. 2017-124608). In addition, as a method of performing the single pass recording with the plurality of inks, there has been proposed a method involving recording an image by applying, to a boundary between a black ink and a color ink, a second black ink having a surface tension comparable to that of the color ink (Japanese Patent Application Laid-Open No. 2008-126619).

### SUMMARY OF THE INVENTION

In order to achieve both an increase in recording speed and downsizing of a recording apparatus, the inventors of the present invention have made investigations on recording an image by single pass through use of a recording head of a serial type adopting a mechanism for flowing an ink in the vicinity of an ejection orifice (circulation serial head), which has been proposed in Japanese Patent Application Laid-Open No. 2017-124608. As a result, even after an ejection operation was paused for a predetermined time period, the ejection stability of the ink was improved, and the frequency of the preliminary ejection operation performed during scanning of the recording head was able to be reduced. Next, the inventors have made investigations on recording an image by single pass by loading a plurality of inks whose surface tensions are uniformized, which have been proposed in Japanese Patent Application Laid-Open No. 2008-126619, into the circulation serial head. As a result, the inventors have found that there arises a new problem in that a positional shift between ruled lines recorded with the plurality of inks and variations in their line widths may occur under specific scanning conditions.

Accordingly, an object of the present invention is to provide an ink jet recording method capable of recording a high-quality image in which a positional shift between ruled lines recorded with a plurality of inks through use of a circulation serial head and variations in their line widths are reduced. In addition, another object of the present invention is to provide an ink jet recording apparatus to be used in the ink jet recording method.

That is, according to the present invention, there is provided an ink jet recording method including recording an image by ejecting an ink from a recording head including: a plurality of ejection orifices each configured to eject the ink; an ejection element configured to generate energy for ejecting the ink; and a first flow path and a second flow path which communicate to each other between each of the plurality of ejection orifices and the ejection element and inside which the ink flows, the ink jet recording method including: an ejection step of ejecting the ink from the plurality of ejection orifices; and a flow step, which is separate from the ejection step, of flowing the ink in the first flow path into the second flow path, wherein the recording head is a recording head of a serial type which includes an ejection element substrate including a plurality of ejection orifice arrays each having the plurality of ejection orifices arranged in a predetermined direction and which is scanned in a direction intersecting with an arrangement direction of the ejection orifice arrays, wherein the first flow path and the second flow path are arranged in parallel to a scanning direction of the recording head and have the same flow direction of the ink, wherein the plurality of ejection orifice arrays include a first ejection orifice array configured to eject a first ink and a second ejection orifice array configured to eject a second ink, and the first ejection orifice array and the second ejection orifice array are arranged on an upstream side and on a downstream side, respectively, with respect to the flow direction of the ink, and wherein a static surface tension γs₁ of the first ink and a static surface tension γs₂ of the second ink satisfy a relationship of γs₁<γs₂.

According to the present invention, the ink jet recording method capable of recording a high-quality image in which a positional shift between ruled lines recorded with a plurality of inks through use of a circulation serial head and variations in their line widths are reduced can be provided. In addition, according to the present invention, the ink jet recording apparatus to be used in the ink jet recording method can be provided.

Further features of the present invention will become apparent from the following description of exemplary embodiments with reference to the attached drawings.

### BRIEF DESCRIPTION OF THE DRAWINGS

FIG. 1 is a schematic view for illustrating the state of a vicinity of an ejection orifice of a recording head.

FIG. 2 is a perspective view for schematically illustrating an ink jet recording apparatus according to one embodiment.

FIG. 3A and FIG. 3B are each a schematic view for illustrating an internal configuration of the ink jet recording apparatus.

FIG. 4 is a schematic view for illustrating an arrangement example of ejection orifice arrays and an example of a circulation flow direction of an ink in the recording head.

FIG. 5A and FIG. 5B are each a schematic view for illustrating the flow state of an ink in the recording head during scanning of the recording head.

FIG. 6 is a schematic view for illustrating recording of a ruled line by dot-on-dot.

FIG. 7 is a perspective view for illustrating a cross-section of an ejection element substrate.

FIG. 8 is a schematic view for illustrating an ink supply system.

FIG. 9A and FIG. 9B are each a schematic view for illustrating the flow state of an ink in the vicinity of the ejection orifice.

FIG. 10 is a sectional view for partially illustrating an example of the recording head.

FIG. 11 is a schematic view for illustrating patterns of an image recorded in Examples.

### DESCRIPTION OF THE EMBODIMENTS

The present invention is described in more detail below by way of exemplary embodiments. In the present invention, when a compound is a salt, the salt is present in a state of dissociating into ions in an ink, but the expression “contains the salt” is used for convenience. In addition, an aqueous ink for ink jet is sometimes simply described as “ink”. A first flow path and a second flow path are sometimes collectively described as “flow path”. Similarly, a first ink and a second ink are sometimes collectively described as “ink”. A secondary color ruled line recorded with two inks is sometimes simply described as “ruled line”. In the present invention, ejection accuracy is evaluated through utilization of a “ruled line” because a state in which the adhesion position of an ink droplet shifts from a target position is easily recognized, but an image recorded by an ink jet recording method or ink jet recording apparatus of the present invention is not limited to the ruled line. Physical property values are values at normal temperature (25° C.) unless otherwise stated.

### <Ink Jet Recording Method and Ink Jet Recording Apparatus>

The ink jet recording apparatus of the present invention includes a recording head including: a plurality of ejection orifices each configured to eject the ink; an ejection element configured to generate energy for ejecting the ink; and a first flow path and a second flow path which communicate to each other between each of the plurality of ejection orifices and the ejection element and inside which the ink flows. The recording head is a recording head of a serial type (serial head) which includes an ejection element substrate including a plurality of ejection orifice arrays each having the plurality of ejection orifices arranged in a predetermined direction and which is scanned in a direction intersecting with an arrangement direction of the ejection orifice arrays. The ink jet recording apparatus of the present invention further includes a flow unit, which is separate from the ejection element, configured to flow the ink in the first flow path into the second flow path. In addition, the ink jet recording method of the present invention is, for example, a method including using the above-mentioned ink jet recording apparatus and recording an image by ejecting an ink from the above-mentioned recording head. That is, the ink jet recording method of the present invention includes: an ejection step of ejecting the ink from the plurality of ejection orifices; and a flow step, which is separate from the ejection step, of flowing the ink in the first flow path into the second flow path.

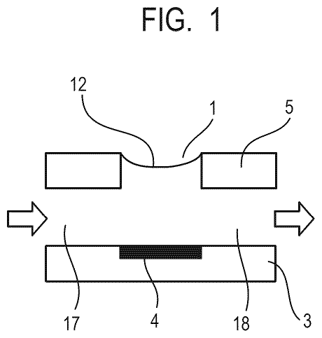

FIG. 1 is a schematic view for illustrating the state of a vicinity of the ejection orifice of the recording head. The recording head illustrated in FIG. 1 includes: an ejection orifice 1 configured to eject an ink; an ejection element 4 configured to generate energy for ejecting the ink; and a first flow path 17 and a second flow path 18 which communicate to each other between the ejection orifice 1 and the ejection element 4 and inside which the ink flows. As described later in the description of an ejection element substrate of the recording head, the ejection orifice 1 is formed on an ejection orifice forming member 5, and the ejection element 4 is arranged on a substrate 3. The ink passes between the ejection orifice 1 and the ejection element 4 and flows from the first flow path 17 into the second flow path 18 (in a direction indicated by the arrow of FIG. 1). When the ink does not flow, evaporation of water from a meniscus 12 of the ink in the ejection orifice 1 proceeds, and along with this, the ink present between the ejection orifice 1 and the ejection element 4 is gradually thickened. Accordingly, when an ejection pause time is long, the ink may be hardly ejected owing to an increase in its fluid resistance at the time of the next ejection operation. Meanwhile, when the ink flows in the direction indicated by the arrow of FIG. 1, even in the case where water evaporates from the meniscus 12, the ink is successively supplied between the ejection orifice 1 and the ejection element 4 through a circulation flow, and hence the thickening of the ink is suppressed, with the result that the occurrence of a state in which the ink is hardly ejected can be prevented.

The inventors of the present invention have combined the recording head of a serial type configured to cause a circulation flow (circulation serial head) as illustrated in FIG. 1 and a plurality of inks, and recorded an image by ejecting the plurality of inks from the ejection orifices. As a result, even after an ejection operation was paused for a predetermined time period, the ejection stability of the ink was improved, and the frequency of a preliminary ejection operation performed during scanning of the recording head was able to be reduced. However, the inventors have found that there arises a new problem in that a positional shift between secondary color ruled lines recorded with the plurality of inks and variations in their line widths may occur under specific scanning conditions. The inventors have examined in detail the reasons for the occurrence of the positional shift between ruled lines and variations in their line widths, and as a result, have found that the following phenomena occur.

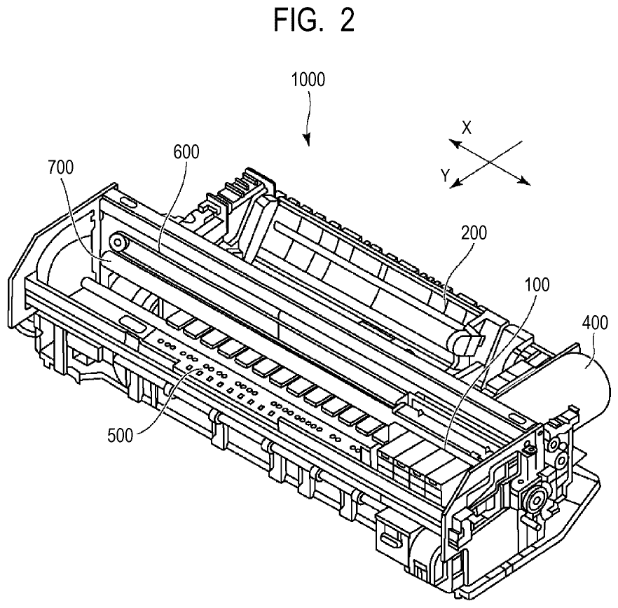

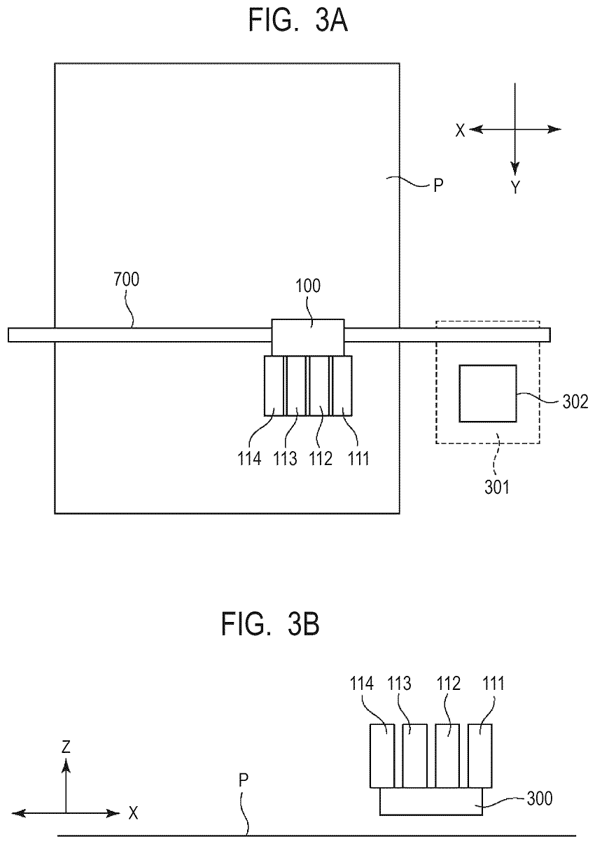

First, the ink jet recording apparatus having the circulation serial head mounted thereon is described. FIG. 2 is a perspective view for schematically illustrating an ink jet recording apparatus 1000 according to one embodiment. A plurality of recording mediums can be loaded into a feed unit 200, and the recording mediums are each fed with a feed roller (not shown). A recording medium P (see FIG. 3A and FIG. 3B) of this embodiment is described by taking as an example a cut sheet having been cut into a predetermined size, but the present invention is not limited thereto and may also be adopted in a mode of recording on a roll sheet.

The recording medium fed by the feed unit 200 is conveyed in a Y direction (conveying direction) by a conveying unit including a conveying roller (not shown), and is moved to a recording position opposite to an ejection unit (recording head) 300 configured to eject an ink (see FIG. 3B). A carriage 100 has the ejection unit (recording head) 300 mounted thereon, and is reciprocally scanned in an X direction (main scanning direction) intersecting with the Y direction along a guide shaft 700 through a timing belt 600 by the driving of a carriage motor 400.

After an image is recorded on a unit area through the movement of the carriage 100 in the X direction and an ink ejection operation by the ejection unit (recording head) 300, the recording medium is conveyed in the Y direction by the conveying unit. The unit area may be arbitrarily set to, for example, “one band” that can be recorded by the arrangement width of the ejection orifice arrays arranged along the Y direction in the ejection unit 300 and one movement of the ejection unit 300 in the X direction, or “one” pixel corresponding to the resolution of the recording head. With the recording head of a serial type, an image can be recorded on the entire recording medium through a recording operation in which an ink ejection operation of one band and an intermittent conveying operation are repeated. In this embodiment, the X direction and the Y direction are orthogonal to each other.

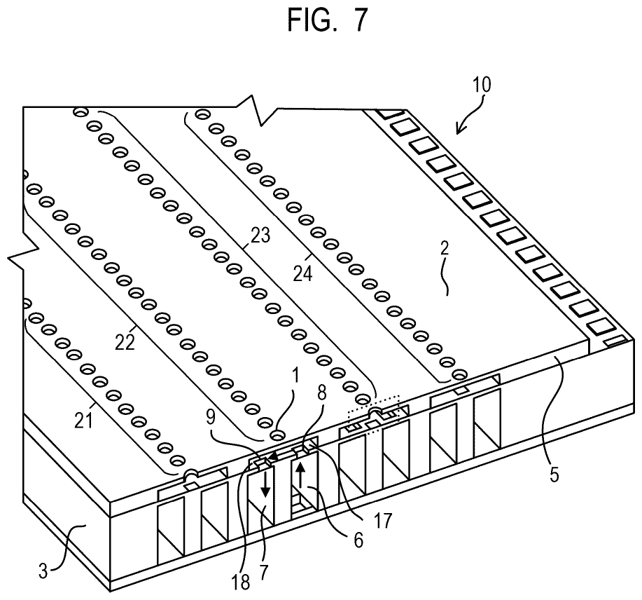

In addition, a platen 500 configured to support the recording medium from a vertically downward direction is arranged in a recording region which is located at a position opposite to the ejection unit (recording head) 300 and in which recording is performed by the ejection unit (recording head) 300. With the platen 500, a recording surface of the recording medium and an ejection orifice surface 2 (FIG. 7) of the ejection unit (recording head) 300 having arranged thereon the ejection orifices each configured to eject an ink are kept at a predetermined distance.

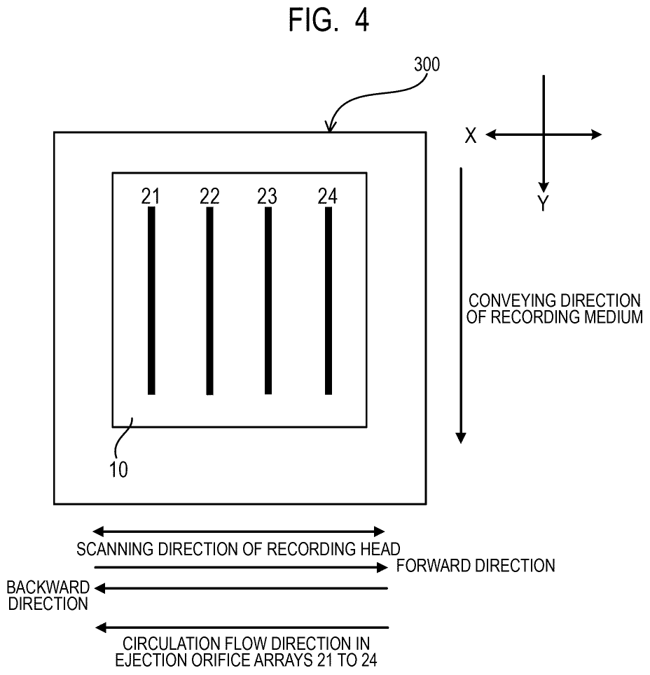

FIG. 3A and FIG. 3B are each a schematic view for illustrating an internal configuration of the ink jet recording apparatus 1000 according to one embodiment of the present invention. FIG. 3A is a schematic top view of the recording apparatus 1000 when seen from above, and FIG. 3B is a schematic side view of the recording apparatus 1000 when seen from front. The carriage 100 has detachably mounted thereon an ink cartridge configured to store an ink to be supplied to the ejection unit (recording head) 300. A plurality of ink cartridges 111, 112, 113 and 114 correspond to ejection orifice arrays 21, 22, 23 and 24 (see FIG. 4), respectively, and are configured to supply an ink to the respective ejection orifice arrays. For example, ejection orifice arrays and ink cartridges corresponding to respective colors of cyan, magenta, yellow and black (CMYK) are arranged.

In addition, a cap 302 for capping the ejection orifice surface 2 of the ejection unit (recording head) 300 is arranged within the movement region of the carriage 100 and outside the region (recording region) through which the recording medium P passes. The position of the carriage 100 (the ejection unit (recording head) 300) at which the ejection orifice surface 2 of the ejection unit (recording head) 300 faces the cap 302 is also referred to as “home position 301”. The cap 302 is connected to a suction unit (not shown), and when the suction unit is driven under a state in which the ejection orifice surface 2 is capped, the ink is sucked from the ejection unit (recording head) 300.

FIG. 4 is a schematic view for illustrating an arrangement example of the ejection orifice arrays in the ejection unit (recording head) 300 and an example of a circulation flow direction, which is the flow direction of an ink. A state in which the ejection unit (recording head) 300 illustrated in FIG. 3B is seen from a recording medium P side is illustrated in FIG. 4. As illustrated in FIG. 4, the ejection unit (recording head) 300 is a recording head of a serial type that includes an ejection element substrate 10 including the four ejection orifice arrays 21, 22, 23 and 24, and is scanned in the X direction intersecting with the arrangement direction of the ejection orifice arrays 21 to 24. In addition, all the four ejection orifice arrays 21 to 24 have the same circulation flow direction from right to left, which is parallel to the X direction (scanning direction). The ejection unit (recording head) 300 is reciprocally moved in a forward direction from left to right and in a backward direction from right to left. Accordingly, the scanning direction and the circulation flow direction are the same direction at the time of backward direction and reverse directions at the time of forward direction.

Next, a site at which the positional shift between ruled lines and variations in their line widths occur and reasons for the occurrence are described. The above-mentioned ink jet recording apparatus, and the ejection orifice array 24 and the ejection orifice array 21 located on the most upstream side and on the most downstream side, respectively, with respect to the flow direction of an ink in its ejection unit (recording head) 300 were used to record secondary color ruled lines on a center portion and both end portions in the width direction (X direction) of a recording medium by single pass recording. Specifically, the following operations were repeatedly performed: secondary color ruled lines were recorded on three points of the recording medium, the center portion and both the end portions, in the forward direction of the X direction; the recording medium was then conveyed by one band in the Y direction; and secondary color ruled lines were recorded on the three points of the recording medium, the center portion and both the end portions, in the backward direction of the X direction. As a result, it was found that a ruled line recorded on the end portion of the recording medium on a home position side immediately after the ejection unit (recording head) 300 was switched from the backward direction to the forward direction was thicker than any other ruled line. In addition, it was found that a phenomenon in which the position of the ruled line was moved to a more outer side (home position side) than expected occurred.

The inventors of the present invention have observed in detail the ruled line recorded on the home position side of the recording medium. As a result, of dots for forming the ruled line, a dot formed of an ink droplet ejected from the ejection orifice array 24 was moved toward the home position side as compared to a dot formed of an ink droplet ejected from the ejection orifice array 21. Further, the inventers have made examinations by using the other ejection orifice arrays, and as a result, have found that the degree of movement of a dot formed of an ink droplet toward the home position side is increased more in the order of the ejection orifice arrays 21, 22, 23 and 24. That is, the inventers have found that a dot formed of an ink droplet first ejected from the ejection orifice array 24 immediately after switching from the backward direction to the forward direction has the largest positional shift. The inventors of the present invention have presumed the reasons for the occurrence of such phenomena to be as described below.

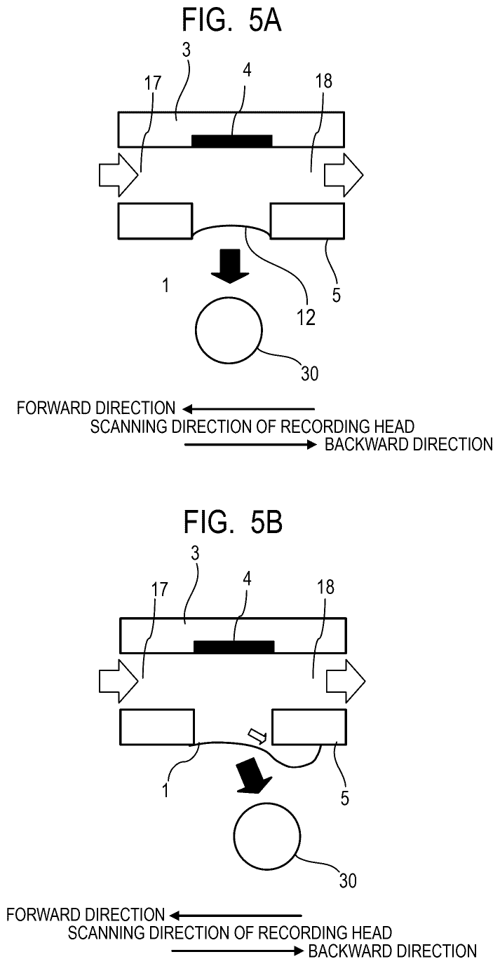

FIG. 5A and FIG. 5B are each a schematic view for illustrating the flow state of an ink in the recording head during scanning of the recording head. When recording is started through use of the circulation serial head, while the recording head is scanned in the forward direction from the home position, is switched from the forward direction to the backward direction, and is scanned on the recording medium, the meniscus 12 in the ejection orifice 1 is stable as illustrated in FIG. 5A. It is conceived that, at this time, an ink droplet 30 is normally formed from the stable meniscus 12, and is ejected in a vertical direction with respect to the ejection orifice surface of the recording head. Accordingly, a positional shift of a dot formed of the ink droplet 30 is less liable to occur.

After that, immediately after the recording head is switched from the backward direction to the forward direction, that is, when the recording head instantaneously stops in the vicinity of the home position, an inertial force acts on the ink in the vicinity of the ejection orifice 1. The inventors of the present invention have presumed that, at this time, the following phenomena occur as illustrated in FIG. 5B: the meniscus in the ejection orifice 1 is broken, and the ink overflows on a downstream side of the circulation flow. When the ink is ejected under that state, the ink droplet 30 is ejected not in the vertical direction with respect to the ejection orifice surface of the recording head, but in a curved manner in the direction of a slightly downstream side of the circulation flow. The inventors have presumed as follows: even when the ink overflows, the ink is promptly sucked into the ejection orifice 1 to reform the meniscus 12, and hence as the ejection orifice array is moved more to the downstream side of the circulation flow, the ejection orifice array is subjected to less influence, with the result that a positional shift of a dot formed of the ink droplet 30 is less liable to occur in a portion other than the end portion. As described above, the inventors of the present invention have presumed that the above-mentioned phenomena are caused by the inertial force that acts when the circulation flow direction of the ink and the scanning direction of the recording head are the same, and after that, the recording head instantaneously stops.

The inventors of the present invention have made investigations on a method for improving ejection accuracy and suppressing the occurrence of the above-mentioned positional shift between ruled lines and variations in their line widths. Specifically, the inventors have made investigations on requirements required for suppressing the occurrence of the positional shift between ruled lines and variations in their line widths even when the ink overflows from the ejection orifice owing to the inertial force. As a result, the inventors have found that the occurrence of the positional shift between ruled lines and variations in their line widths can be suppressed when the following relationship is established: the static surface tension of the ink ejected from the ejection orifice array arranged on an upstream side with respect to the flow direction of the ink is lower than the static surface tension of the ink ejected from the ejection orifice array arranged on a downstream side with respect to the flow direction of the ink.

As used herein, of the plurality of ejection orifice arrays in the recording head, an ink ejection orifice array arranged on an upstream side with respect to the flow direction of the ink is sometimes described as “first ejection orifice array”, and an ink ejected from the first ejection orifice array is sometimes described as “first ink”. In addition, an ink ejection orifice array arranged on a downstream side with respect to the flow direction of the ink is sometimes described as “second ejection orifice array”, and an ink ejected from the second ejection orifice array is sometimes described as “second ink”. The “upstream side” and “downstream side” with respect to the flow direction of the ink in the plurality of ejection orifice arrays mean a relative relationship between two ejection orifice arrays to be compared.

The inventors of the present invention have presumed the reasons why a high-quality image in which a positional shift between ruled lines and variations in their line widths are reduced can be recorded when a static surface tension γs₁ of the first ink and a static surface tension γs₂ of the second ink satisfy the relationship of γs₁<γs₂ as described above to be as described below.

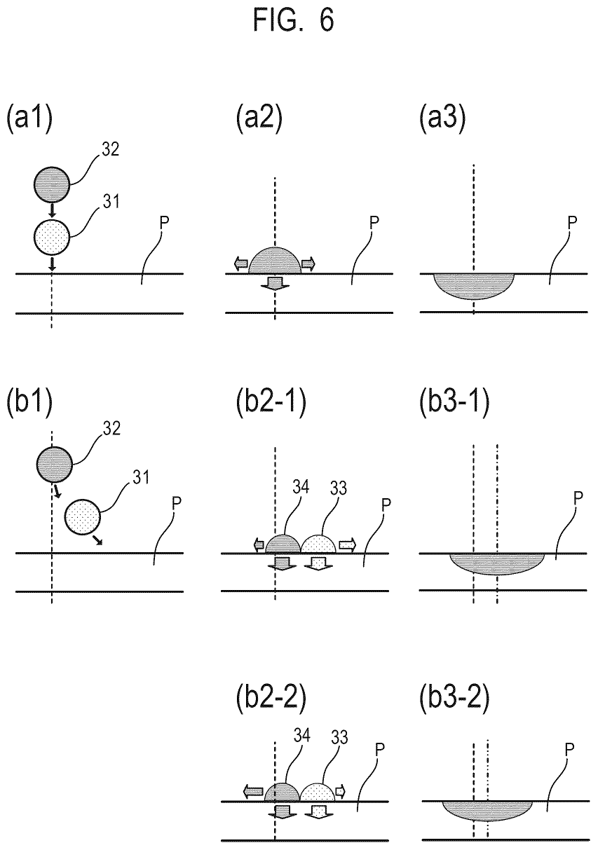

The description is made below by taking as an example the case in which a ruled line is recorded so that dots formed of ink droplets of a plurality of inks are superimposed on each other (by dot-on-dot) with reference to FIG. 6. The broken line of FIG. 6 represents a center line of a target position of an ink droplet. Under a state in which an ink does not overflow, in the case of recording in the forward direction, an ink droplet 31 of the first ink and an ink droplet 32 of the second ink (see (a1) of FIG. 6) adhere to and are fixed to the target position on the recording medium P so as to be superimposed on each other as illustrated in (a2) and (a3) of FIG. 6, and thus a ruled line is recorded. Meanwhile, under a state in which an ink overflows, the ink droplet 31 of the first ink is ejected on the downstream side of the circulation flow (in the right direction in (b1) of FIG. 6) as compared to the ink droplet 32 of the second ink, and hence the ink droplet 31 and the ink droplet 32 adhere to the recording medium P so as to be adjacent to each other as illustrated in each of (b2-1) and (b2-2) of FIG. 6.

At this time, in the case where the static surface tension γs₁ of the first ink on the upstream side is equal to or higher than the static surface tension γs₂ of the second ink on the downstream side, a force of drawing a dot 33 of the first ink toward a dot 34 of the second ink, which has adhered on a side closer to the target position, is hardly generated. A schematic view in the case where the static surface tension γs₁ of the first ink is higher than the static surface tension γs₂ of the second ink is illustrated in each of (b2-1) and (b3-1) of FIG. 6. In this case, the position of a ruled line to be recorded is moved to a first ink side on the upstream side (see the long dashed dotted line in (b3-1) of FIG. 6), and its line width is also thickened as compared to that in the case of (a3) of FIG. 6.

Herein, when the static surface tension γs₁ of the first ink and the static surface tension γs₂ of the second ink satisfy the relationship of γs₁<γs₂, the dot 33 of the first ink can be drawn toward the dot 34 of the second ink, which has adhered on a side closer to the target position, as illustrated in (b2-2) of FIG. 6. Thus, as illustrated in (b3-2) of FIG. 6, a positional shift of a ruled line and its line width can be made closer to those in the case of recording under a state in which the ink does not overflow as illustrated in (a3) of FIG. 6 (see the long dashed double dotted line in (b3-2) of FIG. 6). As a result, the inventors of the present invention have presumed that, even when the ink overflows from the ejection orifice owing to the inertial force, which is a phenomenon specific to the circulation serial head, ruled lines with suppressed variations can be recorded in the center portion and both the end portions of the recording medium.

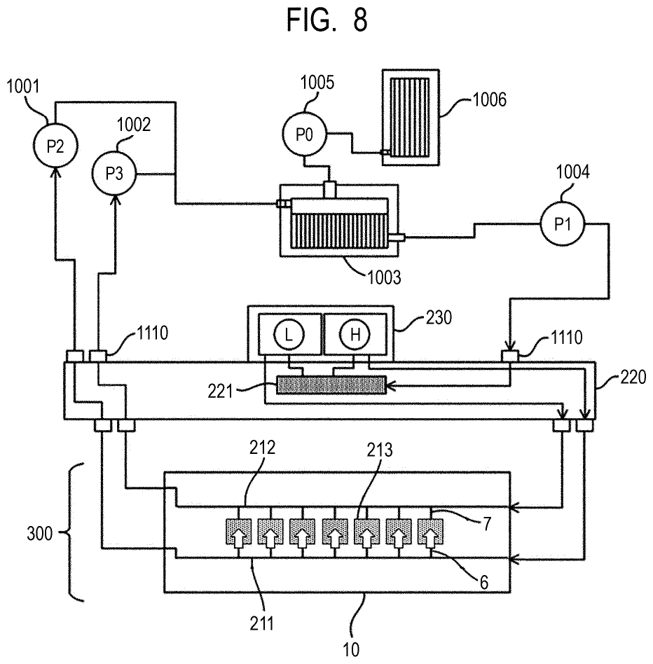

FIG. 7 is a perspective view for illustrating a cross-section of the ejection element substrate. As illustrated in FIG. 7, the ejection element substrate 10 includes: the ejection orifice forming member 5 having formed therein the ejection orifices 1; and the substrate 3 having arranged thereon an ejection element (not shown). The lamination of the ejection orifice forming member 5 and the substrate 3 forms the first flow path 17 and the second flow path 18 through which the ink flows. The first flow path 17 is a region from an inflow port 8, into which the ink in an inflow path 6 flows, to a portion between each of the ejection orifices 1 and the ejection element (FIG. 8, a liquid chamber 213). In addition, the second flow path 18 is a region from the portion between the ejection orifice 1 and the ejection element (FIG. 8, the liquid chamber 213) to an outflow port 9 from which the ink flows out to an outflow path 7. For example, when a pressure difference is made between the inflow port 8 and the outflow port 9 like the inflow port 8 having a high pressure and the outflow port 9 having a low pressure, the ink can be flowed from the high pressure to the low pressure (in a direction indicated by the arrows in FIG. 7). The ink that has passed the inflow path 6 and the inflow port 8 enters the first flow path 17. Then, the ink that has passed through the portion between the ejection orifice 1 and the ejection element (FIG. 8, the liquid chamber 213) passes through the second flow path 18 and the outflow port 9 and flows into the outflow path 7.

The flow step of flowing the ink in the first flow path into the second flow path is a step separate from (a step different from) the ejection step of ejecting the ink from the ejection orifice. In addition, the flowing of the ink from the first flow path into the second flow path in the flow step is preferably performed separately from the loading of the ink between the ejection orifice and the ejection element. The flow step is preferably a step of flowing the ink in the first flow path into the second flow path without discharging the ink from the ejection orifice. The discharge of the ink from the ejection orifice includes a recovery operation, such as preliminary ejection or suction. During the recovery operation of the recording head, the flowing of the ink from the first flow path into the second flow path may be stopped. Further, in the flow step, the ink is preferably flowed from the first flow path into the second flow path by the flow unit, which is separate from the ejection element.

Further details about the ink jet recording method and ink jet recording apparatus of the present invention are described below by taking as an example a recording head of a thermal system configured to eject an ink by generating air bubbles through utilization of an ejection element configured to generate thermal energy. However, even a recording head of a piezo system or a recording head adopting any other ejection system can be applied to the ink jet recording method and ink jet recording apparatus of the present invention. Herein, the description is made by taking as an example a mode of circulating an ink between an ink storage portion and the recording head, but any other mode may be adopted. For example, the following mode may be adopted: two ink storage portions are arranged on an upstream side and a downstream side of the recording head, and an ink is flowed from one of the ink storage portions to the other ink storage portion. Further, the description is made by taking as an example a recording head having incorporated therein an ejection element substrate on which four ejection orifice arrays capable of ejecting inks of four colors of CMYK are arranged, but a recording head including ejection orifice arrays capable of ejecting two or more kinds of inks may be used. In the present invention, a recording head configured to eject an ink by a thermal system is particularly preferably used.

In the flow step, it is preferable that the ink be continuously flowed or intermittently flowed. Details about a method of continuously flowing the ink and a method of intermittently flowing the ink are described below. First, with reference to FIG. 8, the method of continuously flowing the ink is described. FIG. 8 is a schematic view for illustrating an ink supply system. The ejection unit (recording head) 300 illustrated in FIG. 8 is connected to a first circulation pump (high-pressure side) 1001, a first circulation pump (low-pressure side) 1002, a sub tank 1003, a second circulation pump 1004 and the like. For simplification of the description, only a flow path for an ink of one color is illustrated in FIG. 8, but in actuality, flow paths for four colors of CMYK are each arranged in the ejection unit (recording head) 300.

The sub tank 1003 connected to a main tank 1006 serving as an ink storage portion has an air communication port (not shown) and hence can discharge air bubbles mixed into an ink to the outside. The sub tank 1003 is also connected to a replenishment pump 1005. The ink is consumed in the ejection unit (recording head) 300 by the ejection (discharge) of the ink from the ejection orifice in, for example, image recording or suction recovery. The replenishment pump 1005 transfers the ink corresponding to the consumed amount from the main tank 1006 to the sub tank 1003.

The first circulation pump (high-pressure side) 1001 and the first circulation pump (low-pressure side) 1002 each flow the ink in the ejection unit (recording head) 300 that has been flowed out of a connection portion 1110 to the sub tank 1003. A positive-displacement pump having a quantitative liquid-delivering ability is preferably used as each of the first circulation pump (high-pressure side) 1001 and the first circulation pump (low-pressure side) 1002. Specific examples of such positive-displacement pump may include a tube pump, a gear pump, a diaphragm pump and a syringe pump. At the time of the driving of each of the ejection unit 300, the ink can be flowed into a common inflow path 211 and a common outflow path 212 by the first circulation pump (high-pressure side) 1001 and the first circulation pump (low-pressure side) 1002.

A negative pressure control unit 230 includes two pressure adjusting mechanisms in which control pressures different from each other are set. A pressure adjusting mechanism (high-pressure side) H and a pressure adjusting mechanism (low-pressure side) L are connected to the common inflow path 211 and the common outflow path 212 in the ejection unit 300 via a supply unit 220 having arranged therein a filter 221 that removes foreign matter from an ink, respectively.

The supply unit 220 and the ejection unit (recording head) 300 are connected to each other via an ink supply tube (not shown) serving as an ink supply path. The ejection unit (recording head) 300 is subjected to reciprocal scanning in the ink jet recording apparatus, and hence the ink supply tube is formed of a resin material having such flexibility as to be capable of withstanding the reciprocal scanning.

The ejection unit 300 has arranged therein the common inflow path 211, the common outflow path 212, and the inflow path 6 and the outflow path 7 that communicate to the liquid chamber 213 serving as a portion between each of the ejection orifices 1 and the ejection element (not shown). The inflow path 6 and the outflow path 7 communicate to the common inflow path 211 and the common outflow path 212. Accordingly, a flow (arrow in FIG. 8) in which part of the ink passes the inside of the liquid chamber 213 from the common inflow path 211 to flow into the common outflow path 212 occurs. The arrows in FIG. 7 indicate the flow of the ink in the liquid chamber 213. That is, as illustrated in FIG. 7, the ink in the first flow path 17 flows into the second flow path 18 via a space between the ejection orifice 1 and the ejection element.

As illustrated in FIG. 8, a pressure adjusting mechanism H is connected to the common inflow path 211 and a pressure adjusting mechanism L is connected to the common outflow path 212. Accordingly, a pressure difference occurs between the inflow path 6 and the outflow path 7. Thus, a pressure difference also occurs between the inflow port 8 (FIG. 7) communicating to the inflow path 6 and the outflow port 9 (FIG. 7) communicating to the outflow path 7. When the ink is flowed by the pressure difference between the inflow port and the outflow port, the flow speed (mm/s) of the ink at the time of the flowing is preferably controlled to 1.0 mm/s or more to 100.0 mm/s or less. When the flow speed of the ink is 1.0 mm/s or more, an increase in ink viscosity in the vicinity of the ejection orifice is suppressed at the time when an ejection operation is paused for a predetermined time period, and hence the ejection stability of the ink is easily improved. Meanwhile, when the flow speed of the ink is 100.0 mm/s or less, the stability of the meniscus in the ejection orifice is easily improved, and hence the occurrence of overflow of the ink from the ejection orifice due to the inertial force is easily suppressed, with the result that the positional shift between ruled lines and variations in their line widths are more easily suppressed.

In the ink jet recording method of the present invention, the ink in the first flow path may be flowed into the second flow path even during a recovery operation of the recording head. When the ink flows during the recovery operation of the recording head, the ink constantly flows. When the ink constantly flows, water is liable to evaporate, and hence the concentration of the circulating ink is liable to be increased. In order to suppress an increase in concentration of the ink, it is preferable that a mechanism for adding water to the ink by the elapse of a predetermined time period be arranged in the ink jet recording apparatus. Further, it is preferable that a detector for detecting the concentration of the ink be arranged in the ink jet recording apparatus, and water be added to the ink in conjunction with an increase in concentration of the ink having been detected.

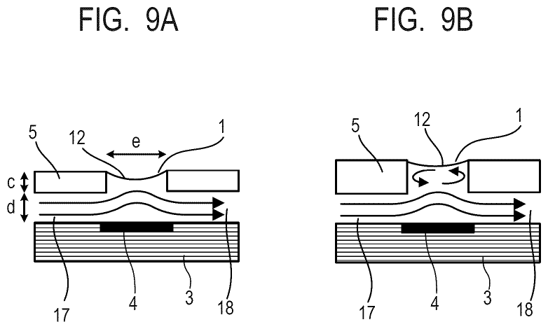

FIG. 9A and FIG. 9B are each a schematic view for illustrating the flow state of an ink in the vicinity of the ejection orifice. The flow state of the ink in the vicinity of the ejection orifice is roughly divided into two kinds: the first one is such a flow state as illustrated in FIG. 9A in which no circulation flow occurs in the vicinity of the meniscus 12 in the ejection orifice 1; and the second one is such a flow state as illustrated in FIG. 9B in which a circulation flow occurs in the vicinity of the meniscus 12 in the ejection orifice 1. Even when the flow speed of the ink in the flow path is comparable, the flow state of the ink in the vicinity of the meniscus 12 may not be constant. It is conceived that which flow state the ink is in depends on a thickness (c) of the ejection orifice forming member 5, a height (d) of the flow path (each of the first flow path 17 and the second flow path 18) and a diameter (e) of the ejection orifice 1, rather than the flow speed of the ink in the flow path. For example, when the height (d) of the flow path and the diameter (e) of the ejection orifice 1 are comparable to each other, in the case where the thickness (c) of the ejection orifice forming member 5 is large, the circulation flow is liable to occur in the vicinity of the meniscus 12 as illustrated in FIG. 9B.

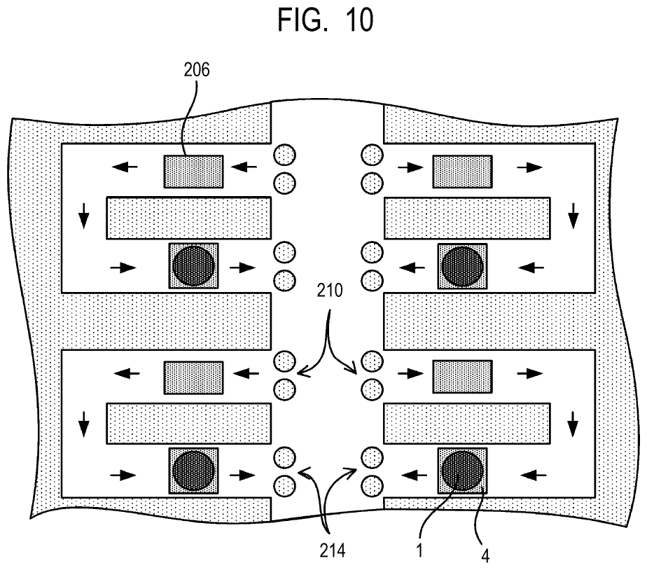

Next, with reference to FIG. 10, the method of intermittently flowing the ink is described. FIG. 10 is a sectional view for partially illustrating an example of the recording head. As illustrated in FIG. 10, the ink, which has flowed in from an inflow port 210, flows in the direction indicated by the arrow by the action of a circulation pump 206 serving as the flow unit of the ink, and flows out from an outflow port 214. In addition, the circulation pump 206 is a pump capable of intermittently flowing the ink. Accordingly, the ink can be intermittently flowed between the ejection orifice 1 and the ejection element 4 by driving the circulation pump 206.

The ink jet recording apparatus of the present invention preferably includes a unit configured to adjust the temperature of the ink in the recording head. In addition, the ink jet recording method of the present invention may further include a step of warming the ink in the recording head. The temperature of the ink in the recording head may be adjusted, for example, by a unit configured to control the temperature of the recording head. Examples of the unit configured to control the temperature of the recording head may include: a heater for temperature adjustment arranged in direct contact with the recording head; and a heater for ink ejection. When the temperature of the recording head is controlled (heated or warmed) by the heater for ink ejection, for example, a current to the extent that the ink is prevented from being ejected may be repeatedly applied. The temperatures of the recording head and the ink in the recording head may be read, for example, with a temperature sensor provided in the recording head. The temperature of the ink in the recording head is preferably adjusted within the range of 40° C. or more to 60° C. or less.

In the case of warming the ink, when the ink is warmed in the case where the static surface tension γs₁ of the first ink and the static surface tension γs₂ of the second ink do not satisfy the relationship of γs₁<γs₂, the stability of the meniscus may be slightly reduced owing to a reduction in ink viscosity. Accordingly, the ink is liable to overflow from the ejection orifice owing to an inertial force, and as a result, the positional shift between ruled lines and variations in their line widths are liable to occur. Meanwhile, when the static surface tension γs₁ of the first ink and the static surface tension γs₂ of the second ink satisfy the relationship of γs₁<γs₂, the occurrence of the positional shift between ruled lines and variations in their line widths can be suppressed.

In the ink jet recording method of the present invention, the scanning speed of the recording head during recording of an image, that is, the moving speed of the recording head during scanning may be set to preferably 30 inches/sec or more, more preferably 35 inches/sec or more from the viewpoint of an increase in recording speed. In addition, the moving speed of the recording head during scanning is preferably set to 70 inches/sec or less. When the moving speed of the recording head during scanning is set to 70 inches/sec or less, an inertial force generated when the recording head stops is suppressed, and thus the ink hardly overflows from the ejection orifice. As a result, the occurrence of the positional shift between ruled lines and variations in their line widths is more easily suppressed.

In the recording head to be used in the ink jet recording method of the present invention, a distance between the first ejection orifice array and the second ejection orifice array may be set to 1.8 mm or less. Any other ejection orifice array may be arranged between the first ejection orifice array and the second ejection orifice array, or the first ejection orifice array and the second ejection orifice array may be adjacent to each other. When the distance between the ejection orifice arrays is short, the ejection orifice arrays can be arranged densely, and hence downsizing and high image quality are easily achieved. Meanwhile, when the distance between the first ejection orifice array and the second ejection orifice array is set to 1.8 mm or less, the second ink ejected from the second ejection orifice array is liable to be affected by the overflow of the ink from the ejection orifice due to an inertial force. As a result, it is conceived that the positional shift between ruled lines and variations in their line widths are liable to occur, but when the static surface tension γs₁ of the first ink and the static surface tension γs₂ of the second ink satisfy the relationship of γs₁<γs₂, the occurrence of the positional shift between ruled lines and variations in their line widths can be suppressed. The distance between the first ejection orifice array and the second ejection orifice array may be set to preferably 0.1 mm or more, more preferably 0.5 mm or more.

The ink jet recording method of the present invention includes a step of recording an image with the above-mentioned ink jet recording apparatus (recording step). In the recording step, specifically, the image is recorded by applying the inks ejected from the ejection orifices of the recording head to the recording medium. Any medium may be used as the recording medium on which the image is to be recorded. Of such mediums, such sheets of paper each having permeability as described below are preferably used: a recording medium free of any coating layer, such as plain paper or uncoated paper; and a recording medium including a coating layer, such as glossy paper or art paper.

The ink jet recording method of the present invention may be free of a step of heating the recording medium to which the ink has been applied through the recording step (heating step). It is conceived that, when the recording medium to which the ink has been applied is heated, a temperature in a main body of the apparatus is increased along with the heating step, and evaporation of water from the meniscus in the recording head is liable to proceed. Accordingly, the heating step may not be performed so that an influence caused by the increase in temperature is reduced, and thus the occurrence of the positional shift between ruled lines and variations in their line widths is easily suppressed.

### <Ink>

The ink jet recording method of the present invention each include a step of recording an image, through use of a plurality of inks, by applying the inks ejected from the ejection orifices of the recording head to a recording medium. The plurality of inks (ink set) includes the first ink to be ejected from an ejection orifice array (first ejection orifice array) arranged on an upstream side with respect to the flow direction of each of the inks and the second ink to be ejected from an ejection orifice array (second ejection orifice array) arranged on a downstream side with respect thereto. In addition, the static surface tension γₛ₁ of the first ink and the static surface tension γₛ₂ of the second ink satisfy the relationship of γₛ₁<γₛ₂.

The static surface tension of the ink may be appropriately controlled by adjusting the kind and amount of a surfactant or a water-soluble organic solvent described later to be incorporated into the ink. The static surface tension of the ink may be adjusted by using the surfactant and the water-soluble organic solvent in combination. The static surface tension of the ink may be measured by a plate method using a platinum plate. In Examples described later, the static surface tension of the ink at 25° C. was measured with an automatic surface tension meter (product name “Model CBVP-Z”, manufactured by Kyowa Interface Science Co., Ltd.).

Within the range in which the static surface tension γₛ₁ of the first ink and the static surface tension γₛ₂ of the second ink satisfy the relationship of γₛ₁<γₛ₂, the values of γₛ₁ and γₛ₂ are each preferably 24 mN/m or more to 42 mN/m or less. A difference in static surface tension between the first ink and the second ink, (γₛ₂−γₛ₁), is preferably 3 mN/m or less, more preferably 2 mN/m or less, and is more than 0 mN/m.

Constituent components of each of the first ink and the second ink and the physical properties of each of the inks are described in detail below.

### (Coloring Material)

A pigment or a dye may be used as a coloring material to be incorporated into the ink. Of those, a pigment is preferable. The content (% by mass) of the coloring material in the ink is preferably 0.10% by mass or more to 15.00% by mass or less, more preferably 0.30% by mass or more to 10.00% by mass or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments. Of those, carbon black and organic pigments are preferable.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Of those, a resin-dispersed pigment is more preferable from the viewpoint of an ejection property.

A dispersant that can disperse the pigment in an aqueous medium through the action of an anionic group is preferably used as a resin dispersant for dispersing the pigment in the aqueous medium. Such a resin as described later, in particular, a water-soluble resin may be used as the resin dispersant. The mass ratio of the content (% by mass) of the pigment in the ink to the content of the resin dispersant therein is preferably 0.3 times or more to 10.0 times or less.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any of acid type and salt type anionic groups. In the case of the salt type anionic group, the group may be in any of a state in which part of the group dissociates or a state in which the entirety thereof dissociates. In the case of the salt type anionic group, a cation serving as a counterion may be, for example, an alkali metal cation, ammonium or an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

A dye having an anionic group is preferably used as the dye. Specific examples of the dye may include dyes, such as azo, triphenylmethane, (aza) phthalocyanine, xanthene and anthrapyridone dyes.

### (Resin)

A resin may be incorporated into the ink. The content (% by mass) of the resin in the ink is preferably 0.10% by mass or more to 20.00% by mass or less, more preferably 0.50% by mass or more to 15.00% by mass or less with respect to the total mass of the ink.

The resin may be added to the ink (i) for stabilizing the dispersed state of the pigment, that is, as a resin dispersant or an aid therefor. In addition, the resin may be added to the ink (ii) for improving the various characteristics of an image to be recorded. Examples of the form of the resin may include a block copolymer, a random copolymer, a graft copolymer and a combination thereof. In addition, the resin may be a water-soluble resin that can be dissolved in an aqueous medium or may be a resin particle to be dispersed in the aqueous medium. The resin particle does not need to include any coloring material. When the resin is used as a dispersant for dispersing the pigment, any other resin is preferably further incorporated into the ink in addition to the resin as a dispersant.

The phrase “resin is water-soluble” as used herein means that when the resin is neutralized with an alkali in an equimolar amount to its acid value, the resin is present in an aqueous medium under a state in which the resin does not form any particle whose particle diameter may be measured by a dynamic light scattering method. Whether or not a resin is water-soluble may be determined in accordance with a method described below. First, a liquid (resin solid content: 10% by mass) containing a resin neutralized with an alkali (e.g., sodium hydroxide or potassium hydroxide) equivalent to its acid value is prepared. Next, the prepared liquid is diluted 10-fold (based on a volume) with pure water to prepare a sample solution. Then, when the particle diameter of the resin in the sample solution is measured by a dynamic light scattering method, and a particle having a particle diameter is not measured, the resin may be determined to be water-soluble. Measurement conditions in this case may be set, for example, as described below.

### [Measurement Conditions]

SetZero: 30 seconds
Number of times of measurement: three times
Measurement time: 180 seconds

A particle size analyzer based on a dynamic light scattering method (e.g., product name “UPA-EX150”, manufactured by Nikkiso Co., Ltd.) or the like may be used as a particle size distribution-measuring apparatus. The particle size distribution-measuring apparatus to be used, the measurement conditions and the like are of course not limited to the foregoing.

The acid value of the water-soluble resin is preferably 100 mgKOH/g or more to 250 mgKOH/g or less. The acid value of the resin for forming the resin particle is preferably 5 mgKOH/g or more to 100 mgKOH/g or less. As used herein, the acid value of the resin may be a value measured by a potentiometric titrator using a potassium hydroxide-methanol titrant. The weight-average molecular weight of the water-soluble resin is preferably 3,000 or more to 15,000 or less. The weight-average molecular weight of the resin for forming the resin particle is preferably 1,000 or more to 2,000,000 or less. As used herein, the weight average molecular weight of the resin can be measured as a polystyrene equivalent value measured by gel permeation chromatography (GPC). The volume-average particle diameter of the resin particle to be measured by a dynamic light scattering method is preferably 100 nm or more to 500 nm or less.

Examples of the resin may include an acrylic resin, a urethane-based resin and an olefin-based resin. Of those, an acrylic resin and a urethane-based resin are preferable.

Resins each having a hydrophilic unit and a hydrophobic unit as its constituent units are each preferable as the acrylic resin. Of those, a resin having a hydrophilic unit derived from (meth)acrylic acid and a hydrophobic unit derived from at least one of a monomer having an aromatic ring and a (meth)acrylic acid ester-based monomer is preferable. A resin having a hydrophilic unit derived from (meth)acrylic acid and a hydrophobic unit derived from at least one monomer of styrene or α-methylstyrene is particularly preferable. Those resins may each be suitably utilized as a resin dispersant for dispersing the pigment because the resins each easily cause an interaction with the pigment.

The hydrophilic unit is a unit having a hydrophilic group such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Specific examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

The urethane-based resin may be obtained by, for example, causing a polyisocyanate and a component reacting therewith (a polyol or a polyamine) to react with each other. In addition, a crosslinking agent or a chain extender may be further caused to react with the reaction product.

The polyisocyanate is a compound having two or more isocyanate groups in a molecular structure thereof. An aliphatic polyisocyanate, an aromatic polyisocyanate or the like may be used as the polyisocyanate. Specific examples of the aliphatic polyisocyanate may include: polyisocyanates each having a chain structure, such as tetramethylene diisocyanate, hexamethylene diisocyanate, dodecamethylene diisocyanate, 2,2,4-trimethylhexamethylene diisocyanate, 2,4,4-trimethylhexamethylene diisocyanate, lysine diisocyanate, 2-methylpentane-1,5-diisocyanate and 3-methylpentane-1,5-diisocyanate; and polyisocyanates each having a cyclic structure, such as isophorone diisocyanate, hydrogenated xylylene diisocyanate, 4,4′-dicyclohexylmethane diisocyanate, 1,4-cyclohexane diisocyanate, methylcyclohexylene diisocyanate and 1,3-bis(isocyanatomethyl)cyclohexane.

Specific examples of the aromatic polyisocyanate may include tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, a dialkyldiphenylmethane diisocyanate, a tetraalkyldiphenylmethane diisocyanate and α,α,α′,α′-tetramethylxylylene diisocyanate.

A polyol may be used as a component that becomes a unit for forming a urethane resin by a reaction with the above-mentioned polyisocyanate. The “polyol” as used herein means a compound having two or more hydroxy groups in a molecule thereof. Specific examples thereof may include: a polyol having no acid group, such as polyether polyol, polyester polyol or polycarbonate polyol; and a polyol having an acid group.

Examples of the polyol having no acid group may include long-chain polyols each having a number-average molecular weight of about 450 to about 4,000, such as polyether polyol, polyester polyol and polycarbonate polyol.

Examples of the polyol having an acid group may include polyols each having an acid group, such as a carboxylic acid group, a sulfonic acid group or a phosphonic acid group, in a structure thereof. In particular, it is preferable to use a water-soluble urethane resin synthesized by further using a polyol having an acid group, such as dimethylol propionic acid or dimethylol butanoic acid, in addition to the polyol having no acid group. The acid group may be in the form of a salt. A cation for forming the salt may be, for example, an ion of lithium, sodium, potassium, ammonium or an organic ammonium. When the water-soluble urethane resin has an acid group, the acid group is typically neutralized by a neutralizing agent, such as a hydroxide of an alkali metal (e.g., lithium, sodium or potassium) or ammonia water, and thus the urethane resin exhibits water solubility.

Examples of the polyamine may include: monoamines each having a plurality of hydroxy groups, such as dimethylolethylamine, diethanolmethylamine, dipropanolethylamine and dibutanolmethylamine; difunctional polyamines, such as ethylenediamine, propylenediamine, hexylenediamine, isophoronediamine, xylylenediamine, diphenylmethanediamine, hydrogenated diphenylmethanediamine and hydrazine; and trifunctional or higher polyamines, such as diethylenetriamine, triethylenetetramine, tetraethylenepentamine, a polyamide polyamine and a polyethylene polyimine. A compound having a plurality of hydroxy groups and one “amino group or imino group” was also given as an example of the “polyamine” for convenience.

At the time of the synthesis of the urethane resin, a crosslinking agent or a chain extender may be used. Typically, the crosslinking agent is used at the time of the synthesis of a prepolymer and the chain extender is used when the prepolymer synthesized in advance is subjected to a chain-extending reaction. Basically, a product appropriately selected from, for example, water, a polyisocyanate, a polyol and a polyamine may be used as the crosslinking agent or the chain extender in accordance with purposes, such as crosslinking and chain extension. An extender that can crosslink the urethane resin may be used as the chain extender.

Examples of the olefin-based resin may include α-olefin polymers, such as polyethylene and polypropylene. The α-olefin polymer has an α-olefin unit, such as an ethylene unit or a propylene unit, as a main constituent unit. The α-olefin polymer may be an ethylene homopolymer or a propylene homopolymer, or may be a copolymer of α-olefins, such as ethylene, propylene, 1-butene, 1-pentene, 1-hexene and 4-methyl-1-pentene. Examples of the copolymer may include a random copolymer, a block copolymer, a graft copolymer and a combination of those copolymers.

### [Resin Particle]

The ink preferably contains the resin particle. When the ink containing the resin particle is used, the meniscus can be more stabilized. The resin particle has less entanglement between molecules unlike the water-soluble resin, and is hence easily moved rapidly to the vicinity of the meniscus along with the flowing of the ink. It is conceived that the meniscus is stabilized by virtue of the interparticle interaction of the resin particle oriented in the vicinity of the meniscus, and thus the occurrence of overflow of the ink from the ejection orifice due to an inertial force is easily suppressed, with the result that the positional shift between ruled lines and variations in their line widths are easily suppressed. Examples of the resin particle may include an acrylic resin particle, an olefin-based resin particle and a urethane-based resin particle.

### [Water-Soluble Urethane Resin]

The ink preferably contains the water-soluble urethane resin. Of the water-soluble resins, the water-soluble urethane resin rapidly exhibits an interaction in the vicinity of the meniscus and forms a stable molecular film. Accordingly, when the ink containing the water-soluble urethane resin is used, the occurrence of overflow of the ink from the ejection orifice due to an inertial force is easily suppressed, with the result that the positional shift between ruled lines and variations in their line widths are easily suppressed.

### [Block Copolymer]

The ink preferably contains the block copolymer. The block copolymer typically has a structure in which a plurality of blocks derived from monomers of the same kind or having similar properties are arranged. A block copolymer to be generally used in an aqueous ink for ink jet has such a structure as described below. There are given, for example: an AB block structure having a hydrophobic block (A block) and an ionic hydrophilic block (B block); and an ABC block structure in which a nonionic hydrophilic block (C block) is further added to the AB block structure. That is, the block copolymer has a structure in which the hydrophilic block and the hydrophobic block are each localized, and hence has high surface activity and is rapidly oriented in the vicinity of the meniscus. Accordingly, when the ink containing the block copolymer is used, the meniscus is stabilized, and thus the occurrence of overflow of the ink from the ejection orifice due to an inertial force is easily suppressed, with the result that the positional shift between ruled lines and variations in their line widths are easily suppressed.

The block copolymer may be synthesized by a general synthesis method, such as an anion living polymerization method, a cation living polymerization method, a group transfer polymerization method, an atom transfer radical polymerization method or a reversible addition-fragmentation chain transfer polymerization method. The block copolymer is preferably the water-soluble resin instead of the resin particle.

### (Surfactant)

The ink preferably contains a surfactant. The surfactant is oriented to a gas-liquid interface so that its hydrophobic group faces an atmospheric side and its hydrophilic group faces an ink side, and hence the meniscus can be further stabilized. Examples of the surfactant may include an anionic surfactant, a nonionic surfactant, a cationic surfactant and an amphoteric surfactant. Of those, a nonionic surfactant is preferably used from the viewpoint of the reliability of the ink.

Examples of the nonionic surfactant may include: a hydrocarbon-based surfactant, such as an ethylene oxide adduct of acetylene glycol or a polyoxyethylene alkyl ether; a fluorine-based surfactant such as a perfluoroalkyl ethylene oxide adduct; and a silicone-based surfactant such as a polyether-modified siloxane compound. Of those, a hydrocarbon-based surfactant is preferable and an ethylene oxide adduct of acetylene glycol is more preferable.

Of the ethylene oxide adducts of acetylene glycol, a compound represented by the following general formula (1) is particularly preferably used. The first ink preferably contains the compound represented by the following general formula (1). The second ink may also contain the compound represented by the following general formula (1):

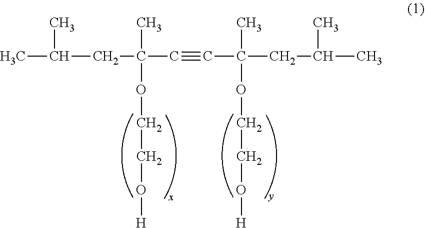

in the general formula (1), “x” and “y” each independently represent a number of 0 or more, and x+y is 0 or more to 50 or less.

The compound represented by the general formula (1) has a high orientation speed to an interface, and hence can be rapidly oriented to the meniscus. Accordingly, even under such a condition that the meniscus is liable to be sucked, for example, the flow speed of the ink is high or high vibration is generated in the meniscus by the ejection, the meniscus can be stabilized. Accordingly, the positional shift between ruled lines and variations in their line widths are easily suppressed. In the general formula (1), “x” and “y” each independently represent a number of 0 or more, preferably 1 or more. In addition, in the general formula (1), x+y is 0 or more to 50 or less, preferably 1 or more to 50 or less, more preferably 1.3 or more to 10 or less. The content (% by mass) of the compound represented by the general formula (1) in the ink is preferably 0.05% by mass or more to 5.00% by mass or less, more preferably 0.10% by mass or more to 3.00% by mass or less with respect to the total mass of the ink.

### (Aqueous Medium)

The ink to be used in the ink jet recording method of the present invention is preferably an aqueous ink containing at least water as an aqueous medium. An aqueous medium that is water or a mixed solvent of water and a water-soluble organic solvent may be incorporated into the ink. Deionized water or ion-exchanged water is preferably used as the water. The content (% by mass) of the water in the aqueous ink is preferably 50.00% by mass or more to 95.00% by mass or less with respect to the total mass of the ink. In addition, the content (% by mass) of the water-soluble organic solvent in the aqueous ink is preferably 3.00% by mass or more to 48.00% by mass or less with respect to the total mass of the ink. Solvents that may be used in an ink for ink jet, such as alcohols, (poly)alkylene glycols, glycol ethers, nitrogen-containing compounds and sulfur-containing compounds, may each be used as the water-soluble organic solvent.

The ink may contain a first water-soluble organic solvent having a relative dielectric constant of 15.0 or less at a temperature of 25° C. as the water-soluble organic solvent. The mass ratio of the content (% by mass) of the first water-soluble organic solvent in the first ink to the total content (% by mass) of the water-soluble organic solvents therein is represented by S₁. In addition, the mass ratio of the content (% by mass) of the first water-soluble organic solvent in the second ink to the total content (% by mass) of the water-soluble organic solvents therein is represented by S₂. At this time, the ratio S₁ and the ratio S₂ of the first ink and the second ink preferably satisfy the relationship of S₁>S₂. The water-soluble organic solvent tends to have higher hydrophobicity as its relative dielectric constant becomes lower. Accordingly, the coloring material (pigment or dye) contained in the ink is more liable to have lower solubility and lower dispersion stability in a water-soluble organic solvent having a lower relative dielectric constant. When the relationship of S₁>S₂ is satisfied, in the case where the first ink and the second ink adhere to the recording medium so as to be at least partially superimposed on each other, the coloring material in the first ink on an upstream side is easily moved toward a dot formed of an ink droplet of the second ink on a downstream side having a lower content of the first water-soluble organic solvent. As a result, the positional shift between ruled lines and variations in their line widths can be further suppressed.

The relative dielectric constants of the water-soluble organic solvent and the water may each be measured with a dielectric constant meter (e.g., product name “BI-870” (manufactured by Brookhaven Instruments Corporation)) under the condition of a frequency of 10 kHz. The “relative dielectric constant” as used herein refers to a value measured at 25° C. In Examples described later, the relative dielectric constant of the water-soluble organic solvent at 25° C. was measured with the above-mentioned dielectric constant meter. The relative dielectric constant of a water-soluble organic solvent that is a solid at 25° C. is a value calculated from the following equation (2) after the measurement of the relative dielectric constant of a 50% by mass aqueous solution thereof. Although the “water-soluble organic solvent” typically refers to a liquid, in the present invention, a solvent that is a solid at 25° C. (normal temperature) is also included in the category of the water-soluble organic solvent.

εₛₒₗ=2ε_{50%}−ε_{water} (2)
εₛₒₗ: The relative dielectric constant of a water-soluble organic solvent that is a solid at 25° C.
ε_{50%}: The relative dielectric constant of a 50% by mass aqueous solution of the water-soluble organic solvent that is a solid at 25° C.
ε_{water}: The relative dielectric constant of water

Herein, the reason why the relative dielectric constant of a water-soluble organic solvent that is a solid at 25° C. is determined from the relative dielectric constant of a 50% by mass aqueous solution thereof is as described below. Of the water-soluble organic solvents that are each a solid at 25° C., some solvents that may each serve as a constituent component for the aqueous ink each have the following difficulty: it is difficult to prepare an aqueous solution having a concentration as high as more than 50% by mass. Meanwhile, in an aqueous solution having a concentration as low as 10% by mass or less, the relative dielectric constant of water becomes dominant to make it difficult to obtain a probable (effective) value of the relative dielectric constant of each of the water-soluble organic solvents. In view of the foregoing, the inventors of the present invention have made an investigation. As a result, the inventors have revealed that out of the water-soluble organic solvents that are each a solid at 25° C., most solvents that may each be used in the ink enable the preparation of aqueous solutions to be subjected to the measurement and their relative dielectric constants to be determined are each consistent with the effect of the present invention. For such reason, the inventors have decided to utilize a 50% by mass aqueous solution. In the case of a water-soluble organic solvent that is a solid at 25° C., the solvent having so low a solubility in water that a 50% by mass aqueous solution thereof cannot be prepared, an aqueous solution having a saturated concentration is utilized and the value of its relative dielectric constant calculated in conformity with the case where the above-mentioned εₛₒₗ is determined is used for convenience.

Examples of the water-soluble organic solvent that is generally used in the aqueous ink and is a solid at 25° C. may include 1,6-hexanediol, trimethylolpropane, ethylene urea, urea and polyethylene glycol having a number-average molecular weight of 1,000.

Specific examples of the first water-soluble organic solvent having a relative dielectric constant of 15.0 or less (a numerical value in parentheses represents a relative dielectric constant at 25° C.) may include 1,2-hexanediol (14.8), propylene glycol monomethyl ether (12.4), n-propanol (12.0), diethylene glycol monobutyl ether (11.0), triethylene glycol monobutyl ether (9.8), tetraethylene glycol monobutyl ether (9.4), ethylene glycol monobutyl ether (9.4), tripropylene glycol monomethyl ether (8.5), 1,6-hexanediol (7.1) and polyethylene glycol having a number-average molecular weight of 600 or 1,000 (11.4 or 4.6, respectively). The relative dielectric constant of the first water-soluble organic solvent is preferably 3.0 or more. Those first water-soluble organic solvents each having a relative dielectric constant of 15.0 or less may be used alone or in combination thereof. In the present invention, the content of the first water-soluble organic solvent does not include those of the surfactant and such an additive as described later. This is because the content of the surfactant or the additive in the ink is generally considerably small, and its influence on the relative dielectric constant is also small.

Specific examples of the water-soluble organic solvent may include the following solvents including the first water-soluble organic solvents each having a relative dielectric constant of 15.0 or less given above (a numerical value in parentheses represents a relative dielectric constant at 25° C.): monohydric alcohols each having 1 to 4 carbon atoms, such as methanol (33.1), ethanol (23.8), n-propanol (12.0), isopropanol (18.3), n-butanol, sec-butanol and tert-butanol; dihydric alcohols, such as 1,2-propanediol (28.8), 1,2-butanediol (22.2), 1,3-butanediol (30.0), 1,4-butanediol (31.1), 1,5-pentanediol (27.0), 1,2-hexanediol (14.8), 1,6-hexanediol (7.1), 2-methyl-1,3-propanediol (28.3), 3-methyl-1,3-butanediol (24.0), 3-methyl-1,5-pentanediol (23.9) and 2-ethyl-1,3-hexanediol (18.5); polyhydric alcohols, such as 1,2,6-hexanetriol (28.5), glycerin (42.3), trimethylolpropane (33.7) and trimethylolethane; alkylene glycols, such as ethylene glycol (40.4), diethylene glycol (31.7), triethylene glycol (22.7), tetraethylene glycol (20.8), dipropylene glycol (19.7), butylene glycol, hexylene glycol and thiodiglycol; glycol ethers, such as ethylene glycol monobutyl ether (9.4), diethylene glycol monomethyl ether, diethylene glycol monoethyl ether, diethylene glycol monobutyl ether (11.0), triethylene glycol monoethyl ether, triethylene glycol monobutyl ether (9.8), tetraethylene glycol monobutyl ether (9.4), propylene glycol monomethyl ether (12.4) and tripropylene glycol monomethyl ether (8.5); polyalkylene glycols each having a number-average molecular weight of 200 to 1,000, such as polyethylene glycol having a number-average molecular weight of 200 (18.9), polyethylene glycol having a number-average molecular weight of 600 (11.5), polyethylene glycol having a number-average molecular weight of 1,000 (4.6) and polypropylene glycol; nitrogen-containing compounds, such as 2-pyrrolidone (28.0), N-methyl-2-pyrrolidone (32.0), 1-(2-hydroxyethyl)-2-pyrrolidone (37.6), 1,3-dimethyl-2-imidazolidinone, N-methylmorpholine, 1-(hydroxymethyl)-5,5-dimethylhydantoin (23.7), 1,3-bis(2-hydroxyethyl)-5,5-dimethylhydantoin (16.0), urea (110.3), ethylene urea (49.7) and triethanolamine (31.9); and sulfur-containing compounds, such as dimethyl sulfoxide (48.9) and bis(2-hydroxyethyl) sulfone. A water-soluble organic solvent having a relative dielectric constant of 3.0 or more, having a relative dielectric constant of 120.0 or less or having a vapor pressure at 25° C. lower than that of water is preferably used as the water-soluble organic solvent to be incorporated into the ink.

### (Other Additives)

The ink may contain, in addition to the above-mentioned components, various additives, such as a defoaming agent, another surfactant, a pH adjustor, a viscosity adjustor, a rust inhibitor, an antiseptic agent, a fungicide, an antioxidant and a reduction inhibitor, as required.

### (Dynamic Surface Tension)

Of the inks to be used in the ink jet recording method of the present invention, the first ink preferably has a dynamic surface tension at 10 milliseconds of 36 mN/m or more. When the first ink has a dynamic surface tension at 10 milliseconds of 36 mN/m or more, a sufficiently stable meniscus can be formed by a capillary force. Moreover, the overflow of the ink, which is caused by an inertial force that acts when the recording head instantaneously stops in the case where the circulation flow direction and the scanning direction are the same, can be reduced. Thus, the positional shift between ruled lines and variations in their line widths can be further suppressed. The dynamic surface tension at 10 milliseconds of each of the first ink and the second ink is preferably 48 mN/m or less. When the dynamic surface tension at 10 milliseconds is 48 mN/m or less, a spread speed is hardly reduced, liquid droplets of the first ink and the second ink are easily brought into contact with each other on the recording medium, and the positional shift between ruled lines and variations in their line widths are easily suppressed.

The dynamic surface tension of the ink is measured by a maximum bubble pressure method. The maximum bubble pressure method is a method involving measuring the maximum pressure required for releasing air bubbles generated at the tip of a probe (capillary tube) inserted into a liquid serving as a measurement target, and determining the surface tension of the liquid from the maximum pressure having been measured. Specifically, the maximum pressure is measured while air bubbles are continuously generated at the tip of the probe. A time period from the time when a new air bubble surface has been generated at the tip of the probe until the maximum bubble pressure (the time when the radius of curvature of the air bubble and the radius of the tip portion of the probe are equal) is reached is referred to as “lifetime”. That is, the maximum bubble pressure method is a method of measuring the surface tension of the liquid in a moving state. The dynamic surface tension at 10 milliseconds of the ink may be easily adjusted, for example, by the kind and content of the water-soluble organic solvent or the surfactant.

### (Viscosity)

The viscosity of the ink is preferably 3.0 mPa's or more and is preferably 10.0 mPa's or less. When the viscosity of the ink is set to 3.0 mPa's or more, a stable meniscus can be formed, and thus the occurrence of overflow of the ink from the ejection orifice due to an inertial force is easily suppressed, with the result that the positional shift between ruled lines and variations in their line widths are easily suppressed. The viscosity of the ink may be measured, for example, with a rotary viscometer.

A viscosity η₁ of the first ink and a viscosity η₂ of the second ink preferably satisfy the relationship of η₁<η₂. When the viscosities of the first ink and the second ink satisfy the relationship of η₁<η₂, the first ink on an upstream side is more easily drawn toward a dot formed of an ink droplet of the second ink on a downstream side, and thus the positional shift between ruled lines and variations in their line widths can be further suppressed. A difference in viscosity between the first ink and the second ink, (η₂−η₁), is preferably 7.0 mPa's or less, more preferably 4.0 mPa's or less.

### EXAMPLES

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

### <Preparation of Resin>

### (Resin Dispersant)

A styrene-ethyl acrylate-acrylic acid copolymer (water-soluble resin) having an acid value of 150 mgKOH/g and a weight-average molecular weight of 8,000 to be used as a resin dispersant was prepared. 20.0 Parts of the resin was neutralized with potassium hydroxide in an equimolar amount to its acid value, and pure water in an appropriate amount was added thereto. Thus, an aqueous solution of a resin dispersant having a resin content (solid content) of 20.00% was prepared.

### (Acrylic Resin)

A styrene-acrylic acid copolymer (acid value: 120 mgKOH/g, weight-average molecular weight: 8,000) serving as a water-soluble resin was dissolved in ion-exchanged water containing potassium hydroxide in an equimolar amount to its acid value. Thus, an aqueous solution of an acrylic resin having a resin content (solid content) of 20.00% was prepared.

### (Urethane Resin)

A four-necked flask including a temperature gauge, a stirring machine, a nitrogen-introducing tube and a reflux tube was prepared. 29 Parts of isophorone diisocyanate, 39 parts of polypropylene glycol having a number-average molecular weight of 2,000, 12 parts of dimethylol propionic acid, 0.02 part of dibutyltin dilaurate and 120 parts of methyl ethyl ketone were loaded into the flask. Then, the contents were caused to react with each other under a nitrogen gas atmosphere at 80° C. for 6 hours. After that, an appropriate amount of methanol was added thereto, and the contents were caused to react with each other at 80° C. until a weight-average molecular weight of 12,000 was achieved. After the reaction, the resultant was cooled to 40° C., and ion-exchanged water was added thereto. While the mixture was stirred with a homomixer at a high speed, a potassium hydroxide aqueous solution was added thereto. Methyl ethyl ketone was evaporated from the resultant resin solution by heating under reduced pressure. Thus, an aqueous solution of a urethane resin having a resin content (solid content) of 20.00% was prepared.

### (Aqueous Dispersion Liquid of Resin Particle)

18.0 Parts of butyl methacrylate, 0.35 part of methacrylic acid, 2.0 parts of a polymerization initiator (2,2′-azobis(2-methylbutyronitrile)) and 2.0 parts of n-hexadecane were loaded into a four-necked flask including a stirring machine, a reflux condenser and a nitrogen gas-introducing tube. A nitrogen gas was introduced into a reaction system, and the contents were stirred for 0.5 hour. 78.0 Parts of a 6.0% aqueous solution of an emulsifier (product name “NIKKOL BC15”, manufactured by Nikko Chemicals Co., Ltd.) was dropped into the reaction system, and the contents were stirred for 0.5 hour to provide a mixture. The mixture was emulsified through ultrasonic irradiation with an ultrasonic irradiator for 3 hours, and was then subjected to a polymerization reaction at 80° C. for 4 hours under a nitrogen atmosphere. The reaction system was cooled to 25° C., followed by filtration and addition of an appropriate amount of pure water. Thus, an aqueous dispersion liquid of a resin particle having a resin particle content of 20.00% was obtained.

### <Preparation of Pigment Dispersion Liquid>

### (Pigment Dispersion Liquid 1)

10.0 Parts of a pigment (C.I. Pigment Blue 15:3), 15.0 parts of the previously prepared aqueous solution of the resin dispersant and 75.0 parts of pure water were mixed to provide a mixture. The resultant mixture and 200 parts of zirconia beads each having a diameter of 0.3 mm were loaded into a batch-type vertical sand mill (manufactured by Aimex Co., Ltd.), and the mixture was dispersed for 5 hours while being cooled with water. After that, the resultant was centrifuged so that a coarse particle was removed. The residue was filtered with a cellulose acetate filter having a pore size of 3.0 μm (manufactured by Advantec) under pressure. Thus, a pigment dispersion liquid 1 having a pigment content of 10.00% and a resin dispersant (resin) content of 3.00% was prepared.

### (Pigment Dispersion Liquid 2)

A pigment dispersion liquid 2 having a pigment content of 10.00% and a resin dispersant (resin) content of 3.00% was obtained by the same procedure as that of the above-mentioned pigment dispersion liquid 1 except that the kind of the pigment was changed to C.I. Pigment Red 122.

### (Pigment Dispersion Liquid 3)

A pigment dispersion liquid 3 having a pigment content of 10.00% and a resin dispersant (resin) content of 3.00% was obtained by the same procedure as that of the above-mentioned pigment dispersion liquid 1 except that the kind of the pigment was changed to C.I. Pigment Yellow 74.

### (Pigment Dispersion Liquid 4)

A pigment dispersion liquid 4 having a pigment content of 10.00% and a resin dispersant (resin) content of 3.00% was obtained by the same procedure as that of the above-mentioned pigment dispersion liquid 1 except that the kind of the pigment was changed to carbon black (specific surface area: 220 m²/g, DBP oil absorption: 105 mL/100 g).

### (Pigment Dispersion Liquid 5)

A pigment dispersion liquid 5 having a pigment content of 10.00% was prepared by adding an appropriate amount of ion-exchanged water to a commercially available pigment dispersion liquid (product name “CAB-O-JET 250C”, manufactured by Cabot Corporation). A pigment in the pigment dispersion liquid 5 is a self-dispersible pigment in which a sulfonic acid group is bonded to a particle surface of a pigment (C.I. Pigment Blue 15:4) via a benzene ring.

### (Pigment Dispersion Liquid 6)

A pigment dispersion liquid 6 having a pigment content of 10.00% was prepared by adding an appropriate amount of ion-exchanged water to a commercially available pigment dispersion liquid (product name “CAB-O-JET 265M”, manufactured by Cabot Corporation). A pigment in the pigment dispersion liquid 6 is a self-dispersible pigment in which a sulfonic acid group is bonded to a particle surface of a pigment (C.I. Pigment Red 122) via a benzene ring.

### (Pigment Dispersion Liquid 7)

A pigment dispersion liquid 7 having a pigment content of 10.00% was prepared by adding an appropriate amount of ion-exchanged water to a commercially available pigment dispersion liquid (product name “CAB-O-JET 270Y”, manufactured by Cabot Corporation). A pigment in the pigment dispersion liquid 7 is a self-dispersible pigment in which a sulfonic acid group is bonded to a particle surface of a pigment (C.I. Pigment Yellow 74) via a benzene ring.

### (Pigment Dispersion Liquid 8)

A pigment dispersion liquid 8 having a pigment content of 10.00% was prepared by adding an appropriate amount of ion-exchanged water to a commercially available pigment dispersion liquid (product name “CAB-O-JET 200”, manufactured by Cabot Corporation). A pigment in the pigment dispersion liquid 8 is a self-dispersible pigment in which a sulfonic acid group is bonded to a particle surface of a pigment (carbon black) via a benzene ring.

### <Preparation of Ink>

Inks were each prepared by mixing and sufficiently stirring the components (unit: %) shown in upper columns of Table 1 (Table 1-1 to Table 1-4), followed by filtration with a cellulose acetate filter having a pore size of 3.0 μm (manufactured by Advantec) under pressure. The terms “ACETYLENOL E60”, “ACETYLENOL E100” and “ACETYLENOL E40” represent the product names of surfactants manufactured by Kawaken Fine Chemicals Co., Ltd., and these products have values of “x+y” in the general formula (1) of “6”, “10” and “4”, respectively. The term “Zonyl FS-3100” represents the product name of a fluorine-based nonionic surfactant manufactured by DuPont. The static surface tension (mN/m), dynamic surface tension (mN/m) at 10 milliseconds and viscosity n (mPa's) of each of the inks are shown in lower columns of Table 1. In addition, the content F (%) of a water-soluble organic solvent having a relative dielectric constant at a temperature of 25° C. of 15.0 or less (first water-soluble organic solvent) in each of the inks, the total content T (%) of water-soluble organic solvents therein and the value (times) of F/T are shown in lower columns of Table 1. The static surface tension of each of the inks was measured under the condition of 25° C. with an automatic surface tension meter (product name “Model CBVP-Z”, manufactured by Kyowa Interface Science Co., Ltd.). The dynamic surface tension of each of the inks was measured under the condition of 25° C. with a dynamic surface tension meter based on a maximum bubble pressure method (product name “BUBBLE PRESSURE TENSIOMETER BP-2”, manufactured by KRUSS). The viscosity of each of the inks was measured under the condition of 25° C. with an E-type viscometer (product name “RE-85L”, manufactured by Toki Sangyo Co., Ltd.).

TABLE 1-1
Composition and characteristics of ink

| | Magenta ink | | | | | | | |
|---|---|---|---|---|---|---|---|---|
| | M1 | M2 | M3 | M4 | M5 | M6 | M7 | M8 |
| Pigment dispersion liquid 1 | | | | | | | | |
| Pigment dispersion liquid 2 | 50.00 | 50.00 | | | 50.00 | 50.00 | 50.00 | 50.00 |
| Pigment dispersion liquid 3 | | | | | | | | |
| Pigment dispersion liquid 4 | | | | | | | | |
| Pigment dispersion liquid 5 | | | | | | | | |
| Pigment dispersion liquid 6 | | | 50.00 | 50.00 | | | | |
| Pigment dispersion liquid 7 | | | | | | | | |
| Pigment dispersion liquid 8 | | | | | | | | |
| Aqueous solution of acrylic | 5.00 | 5.00 | 12.50 | 12.50 | | 5.00 | 5.00 | 5.00 |
| resin | | | | | | | | |
| Aqueous solution of | | | | | 5.00 | | | |
| urethane resin | | | | | | | | |
| Aqueous dispersion liquid | | | | | | 2.50 | | |
| of resin particle | | | | | | | | |
| Glycerin (42.3) | 12.00 | 8.00 | 12.00 | 8.00 | 12.00 | 12.00 | 12.00 | 10.00 |
| Triethylene glycol (22.7) | 2.70 | 12.00 | 2.70 | 12.00 | 2.70 | 2.70 | 3.00 | 3.50 |
| Polyethylene glycol 200 | | 6.00 | | 6.00 | | | | |
| (18.9) | | | | | | | | |
| 1,2-Hexanediol (14.8) | 1.00 | 0.80 | 1.00 | 0.80 | 1.00 | 1.00 | 2.00 | 2.00 |
| Polyethylene glycol 600 | | | | | | | | |
| (11.4) | | | | | | | | |
| 1,6-Hexanediol (7.1) | | | | | | | | |
| Polyethylene glycol 1000 | 3.00 | 1.00 | 3.00 | 1.00 | 3.00 | 3.00 | 1.20 | 3.00 |
| (4.6) | | | | | | | | |
| ACETYLENOL E60 | 0.60 | 0.50 | 0.60 | 0.50 | 0.60 | 0.60 | 1.00 | 0.80 |
| ACETYLENOL E40 | | | | | | | | |
| ACETYLENOL E100 | | | | | | | | |
| Zonyl FS-3100 | | | | | | | | |
| Ion-exchanged water | 25.70 | 16.70 | 18.20 | 9.20 | 25.70 | 23.20 | 25.80 | 25.70 |
| Dynamic surface tension γd | 38 | 39 | 38 | 39 | 38 | 38 | 35 | 36 |
| (mN/m) | | | | | | | | |
| Static surface tension γs | 32 | 33 | 32 | 33 | 32 | 32 | 31 | 31 |
| (mN/m) | | | | | | | | |
| Viscosity η (mPa · s) | 4.0 | 5.0 | 4.0 | 5.0 | 4.0 | 4.0 | 4.0 | 4.2 |
| Content F (%) of first water- | 4.00 | 1.80 | 4.00 | 1.80 | 4.00 | 4.00 | 3.20 | 5.00 |
| soluble organic solvent | | | | | | | | |
| Total content T (%) of | 18.70 | 27.80 | 18.70 | 27.80 | 18.70 | 18.70 | 18.20 | 18.50 |
| water-soluble organic | | | | | | | | |
| solvents | | | | | | | | |
| Value (times) of F/T | 0.21 | 0.06 | 0.21 | 0.06 | 0.21 | 0.21 | 0.18 | 0.27 |

TABLE 1-2
Composition and characteristics of ink

| | Magenta ink | | | | | | | |
|---|---|---|---|---|---|---|---|---|
| | M9 | M10 | M11 | M12 | M13 | M14 | M15 | M16 |
| Pigment dispersion liquid 1 | | | | | | | | |
| Pigment dispersion liquid 2 | 50.00 | 50.00 | 50.00 | 50.00 | 50.00 | 50.00 | 50.00 | 50.00 |
| Pigment dispersion liquid 3 | | | | | | | | |
| Pigment dispersion liquid 4 | | | | | | | | |
| Pigment dispersion liquid 5 | | | | | | | | |
| Pigment dispersion liquid 6 | | | | | | | | |
| Pigment dispersion liquid 7 | | | | | | | | |
| Pigment dispersion liquid 8 | | | | | | | | |
| Aqueous solution of acrylic | 5.00 | 5.00 | 5.00 | 5.00 | 5.00 | 5.00 | 5.00 | 5.00 |
| resin | | | | | | | | |
| Aqueous solution of | | | | | | | | |
| urethane resin | | | | | | | | |
| Aqueous dispersion liquid | | | | | | | | |
| of resin particle | | | | | | | | |
| Glycerin (42.3) | 8.00 | 12.00 | 12.00 | 12.00 | 12.00 | 12.00 | 12.00 | 12.00 |
| Triethylene glycol (22.7) | 12.00 | 12.00 | 4.50 | 3.60 | 1.30 | 4.20 | 3.70 | 12.00 |
| Polyethylene glycol 200 | | | | | | | | |
| (18.9) | | | | | | | | |
| 1,2-Hexanediol (14.8) | 1.00 | 1.00 | 1.00 | 1.00 | 1.00 | 1.00 | 1.00 | 2.00 |
| Polyethylene glycol 600 | | | | | | 3.00 | | |
| (11.4) | | | | | | | | |
| 1,6-Hexanediol (7.1) | | | | | | | 3.00 | |
| Polyethylene glycol 1000 | 4.00 | 4.50 | 3.00 | 3.00 | 3.00 | | | 1.50 |
| (4.6) | | | | | | | | |
| ACETYLENOL E60 | 0.60 | 0.60 | | | | 0.60 | 0.60 | 1.00 |
| ACETYLENOL E40 | | | | 0.30 | | | | |
| ACETYLENOL E100 | | | | | 1.00 | | | |
| Zonyl FS-3100 | | | 0.01 | | | | | |
| Ion-exchanged water | 19.40 | 14.90 | 24.49 | 25.10 | 26.70 | 24.20 | 24.70 | 16.50 |
| Dynamic surface tension γd | 38 | 38 | 38 | 38 | 38 | 38 | 38 | 35 |
| (mN/m) | | | | | | | | |
| Static surface tension γs | 32 | 32 | 32 | 32 | 32 | 32 | 32 | 31 |
| (mN/m) | | | | | | | | |
| Viscosity η (mPa · s) | 5.0 | 5.5 | 4.0 | 4.0 | 4.0 | 4.0 | 4.0 | 5.2 |
| Content F (%) of first | 5.00 | 5.50 | 4.00 | 4.00 | 4.00 | 4.00 | 4.00 | 3.50 |
| water-soluble organic | | | | | | | | |
| solvent | | | | | | | | |
| Total content T (%) of | 25.00 | 29.50 | 20.50 | 19.60 | 17.30 | 20.20 | 19.70 | 27.50 |
| water-soluble organic | | | | | | | | |
| solvents | | | | | | | | |
| Value (times) of F/T | 0.20 | 0.19 | 0.20 | 0.20 | 0.23 | 0.20 | 0.20 | 0.13 |

TABLE 1-3
Composition and characteristics of ink

| | Cyan ink | | | | | | |
|---|---|---|---|---|---|---|---|
| | C1 | C2 | C3 | C4 | C5 | C6 | C7 |
| Pigment dispersion liquid 1 | 50.00 | 50.00 | | 50.00 | 50.00 | 50.00 | 50.00 |
| Pigment dispersion liquid 2 | | | | | | | |
| Pigment dispersion liquid 3 | | | | | | | |
| Pigment dispersion liquid 4 | | | | | | | |
| Pigment dispersion liquid 5 | | | 50.00 | | | | |
| Pigment dispersion liquid 6 | | | | | | | |
| Pigment dispersion liquid 7 | | | | | | | |
| Pigment dispersion liquid 8 | | | | | | | |
| Aqueous solution of acrylic | 5.00 | 5.00 | 12.50 | 5.00 | 5.00 | 5.00 | 5.00 |
| resin | | | | | | | |
| Aqueous solution of | | | | | | | |
| urethane resin | | | | | | | |
| Aqueous dispersion liquid | | | | | | | |
| of resin particle | | | | | | | |
| Glycerin (42.3) | 8.00 | 12.00 | 8.00 | 5.00 | 5.00 | 8.00 | 8.00 |
| Triethylene glycol (22.7) | 12.00 | 2.70 | 12.00 | 8.10 | 6.80 | 11.50 | 9.50 |
| Polyethylene glycol 200 | 6.00 | | 6.00 | 6.00 | 6.00 | 6.00 | 6.00 |
| (18.9) | | | | | | | |
| 1,2-Hexanediol (14.8) | 0.80 | 1.00 | 0.80 | 0.80 | 0.80 | 0.80 | 2.00 |
| Polyethylene glycol 600 | | | | | | | |
| (11.4) | | | | | | | |
| 1,6-Hexanediol (7.1) | | | | | | | |
| Polyethylene glycol 1000 | 1.00 | 3.00 | 1.00 | 4.40 | 5.00 | 1.00 | 1.00 |
| (4.6) | | | | | | | |
| ACETYLENOL E60 | 0.50 | 0.60 | 0.50 | 0.50 | 0.50 | 0.80 | 0.80 |
| ACETYLENOL E40 | | | | | | | |
| ACETYLENOL E100 | | | | | | | |
| Zonyl FS-3100 | | | | | | | |
| Ion-exchanged water | 16.70 | 25.70 | 9.20 | 20.20 | 20.90 | 16.90 | 17.70 |
| Dynamic surface tension γd | 39 | 38 | 39 | 39 | 39 | 38 | 36 |
| (mN/m) | | | | | | | |
| Static surface tension γs | 33 | 32 | 33 | 33 | 33 | 32 | 31 |
| (mN/m) | | | | | | | |
| Viscosity η (mPa · s) | 5.0 | 4.0 | 5.0 | 5.0 | 5.0 | 5.0 | 5.0 |
| Content F (%) of first | 1.80 | 4.00 | 1.80 | 5.20 | 5.80 | 1.80 | 3.00 |
| water-soluble organic | | | | | | | |
| solvent | | | | | | | |
| Total content T (%) of | 27.80 | 18.70 | 27.80 | 24.30 | 23.60 | 27.30 | 26.50 |
| water-soluble organic | | | | | | | |
| solvents | | | | | | | |
| Value (times) of F/T | 0.06 | 0.21 | 0.06 | 0.21 | 0.25 | 0.07 | 0.11 |

TABLE 1-4
Composition and characteristics of ink

| | Yellow ink | | Black ink | |
|---|---|---|---|---|
| | Y1 | Y2 | K1 | K2 |
| Pigment dispersion liquid 1 | | | | |
| Pigment dispersion liquid 2 | | | | |
| Pigment dispersion liquid 3 | 50.00 | | | |
| Pigment dispersion liquid 4 | | | 50.00 | |
| Pigment dispersion liquid 5 | | | | |
| Pigment dispersion liquid 6 | | | | |
| Pigment dispersion liquid 7 | | 50.00 | | |
| Pigment dispersion liquid 8 | | | | 50.00 |
| Aqueous solution of acrylic | 5.00 | 12.50 | 5.00 | 12.50 |
| resin | | | | |
| Aqueous solution of | | | | |
| urethane resin | | | | |
| Aqueous dispersion liquid | | | | |
| of resin particle | | | | |
| Glycerin (42.3) | 12.00 | 12.00 | 8.00 | 8.00 |
| Triethylene glycol (22.7) | 2.70 | 2.70 | 12.00 | 12.00 |
| Polyethylene glycol 200 | | | 6.00 | 6.00 |
| (18.9) | | | | |
| 1,2-Hexanediol (14.8) | 1.00 | 1.00 | 0.80 | 0.80 |
| Polyethylene glycol 600 | | | | |
| (11.4) | | | | |
| 1,6-Hexanediol (7.1) | | | | |
| Polyethylene glycol 1000 | 3.00 | 3.00 | 1.00 | 1.00 |
| (4.6) | | | | |
| ACETYLENOL E60 | 0.60 | 0.60 | 0.50 | 0.50 |
| ACETYLENOL E40 | | | | |
| ACETYLENOL E100 | | | | |
| Zonyl FS-3100 | | | | |
| Ion-exchanged water | 25.70 | 18.20 | 16.70 | 9.20 |
| Dynamic surface tension γd | 38 | 38 | 39 | 39 |
| (mN/m) | | | | |
| Static surface tension γs | 32 | 32 | 33 | 33 |
| (mN/m) | | | | |
| Viscosity η (mPa · s) | 4.0 | 4.0 | 5.0 | 5.0 |
| Content F (%) of first | 4.00 | 4.00 | 1.80 | 1.80 |
| water-soluble organic | | | | |
| solvent | | | | |
| Total content T (%) of | 18.70 | 18.70 | 27.80 | 27.80 |
| water-soluble organic | | | | |
| solvents | | | | |
| Value (times) of F/T | 0.21 | 0.21 | 0.06 | 0.06 |

### Evaluation

An ink jet recording apparatus including a main portion illustrated in each of FIG. 2, FIG. 3A and FIG. 3B was used, the ink is loaded into an ink cartridge illustrated in each of FIG. 3A and FIG. 3B, and the following evaluations were performed under an environment at a temperature of 25° C. and a relative humidity of 50%. A recording head of a serial type having the configuration illustrated in FIG. 4 (circulation serial head) was used as a recording head. The recording head includes, per ejection orifice, a first flow path and a second flow path connected to each other between the ejection orifice and an ejection element, and is configured to flow the ink in the first flow path into the second flow path through utilization of a pump. The number of ejection orifices per ejection orifice array is 256, an ejection orifice density is 600 dpi and an ink ejection amount per ejection orifice is 8 ng. A ruled line to be recorded in each of the following evaluations was recorded by using two ejection orifice arrays under such conditions that ink droplets were applied from the respective ejection orifice arrays one by one in a dot-on-dot manner to a region measuring 1/600 inch by 1/600 inch. An image was recorded under the conditions shown in Table 2 (Tables 2-1-1, 2-1-2, 2-2-1, 2-2-2, 2-3-1, 2-3-2, 2-4-1 and 2-4-2) for inks (ink set of a first ink and a second ink) and ejection orifice arrays (reference numerals in FIG. 4) having been used. In addition, the image was recorded under the conditions shown in Table 2 for the presence or absence of a flow step (circulation flow) in the recording head, the flow speed of the ink, a scanning type, a scanning speed, a distance between the ejection orifice arrays and the presence or absence of warming of the ink in the recording head. The warming of the ink in the recording head was performed so that the ink had a temperature of 40° C. In addition, a preliminary ejection operation of the recording head outside the region of a recording medium was not performed. Further, the recording medium to which the ink had been applied was not subjected to a heating step. The magnitude relationship between the static surface tension γs₁ of the first ink and the static surface tension γs₂ of the second ink, and the magnitude relationship between the viscosity η₁ of the first ink and the viscosity η₂ of the second ink were also shown in Table 2. Further, the magnitude relationship between the ratio S₁ of the content of the first water-soluble organic solvent in the first ink to the total content of water-soluble organic solvents therein and the ratio S₂ of the content of the first water-soluble organic solvent in the second ink to the total content of water-soluble organic solvents therein was also shown in Table 2.

### (Ruled Line Stability)

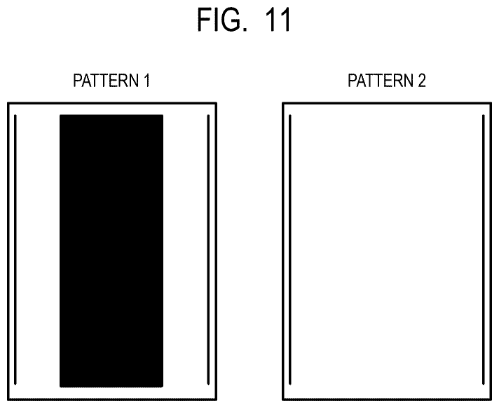

“Pattern 1” including: ruled lines extending in the same direction as the direction of the ejection orifice arrays on both end portions of a recording medium; and a solid portion on a center portion of the recording medium as illustrated in FIG. 11 was recorded by single pass with the first ink and the second ink by using the above-mentioned ink jet recording apparatus and reciprocally scanning the recording head. The solid portion was recorded by using two ejection orifice arrays under such conditions that ink droplets were applied from the respective ejection orifice arrays one by one to a unit area measuring 1/600 inch by 1/600 inch. A medium available under the product name “High-quality exclusive paper HR-101SA4” (manufactured by Canon Inc.) was used as the recording medium. One day after the recording, the line widths of a ruled line having been recorded on the end portion of the recording medium on a home position side in a backward direction during scanning of the recording head on the third time and a ruled line having been recorded on the end portion of the recording medium on the home position side in a forward direction immediately thereafter were measured with an image evaluation apparatus. An apparatus available under the product name “Personal IAS” manufactured by QEA, Inc. was used as the image evaluation apparatus. A line width ratio was calculated by the equation: Line width ratio=(Line width of ruled line recorded in forward direction)/(Line width of ruled line recorded in backward direction) from the line widths of the ruled lines having been measured. Ruled line stability was evaluated in accordance with the following evaluation criteria based on the line width ratio having been calculated and visual observation of the positions of the ruled line recorded in the forward direction and the ruled line recorded in the backward direction. In the present invention, in the following evaluation criteria, while levels “AA”, “A” and “B” were defined as acceptable levels, levels “C” and “D” were defined as unacceptable levels. The results are shown in Table 2.
AA: The line width ratio was less than 1.05.
A: The line width ratio was 1.05 or more to less than 1.10.
B: The line width ratio was 1.10 or more to less than 1.15.
C: The line width ratio was 1.10 or more to less than 1.15, and a positional shift between the ruled line recorded in the forward direction and the ruled line recorded in the backward direction was able to be visually observed.
D: The line width ratio was 1.15 or more, and a positional shift between the ruled line recorded in the forward direction and the ruled line recorded in the backward direction was able to be visually observed.

### (Ejection Stability)

“Pattern 2” including ruled lines extending in the same direction as the direction of the ejection orifice arrays on both end portions of a recording medium as illustrated in FIG. 11 was recorded by single pass with the first ink and the second ink by using the above-mentioned ink jet recording apparatus and reciprocally scanning the recording head. A medium available under the product name “High-quality exclusive paper HR-101SA4” (manufactured by Canon Inc.) was used as the recording medium. Ejection stability was evaluated in accordance with the following evaluation criteria based on visual observation of the ruled lines having been recorded. In the present invention, in the following evaluation criteria, while levels “A” and “B” were defined as acceptable levels, a level “C” was defined as an unacceptable level. The results are shown in Table 2.
A: None of the ruled lines had distortion and non-ejection.
B: The ruled lines had slight distortion but were free of non-ejection in a lower end portion of the recording medium.
C: The ruled lines had distortion and non-ejection in a lower half of the recording medium.

TABLE 2-1-1
Evaluation conditions

| | | Evaluation conditions | | | |
|---|---|---|---|---|---|
| | | First ink | | Second ink | |
| | | | Ejection | | Ejection |
| | | Kind | orifice | Kind | orifice |
| | | of ink | array | of ink | array |
| Example | 1 | M1 | 24 | C1 | 23 |
| | 2 | Y1 | 24 | M2 | 23 |
| | 3 | Y1 | 24 | C1 | 23 |
| | 4 | Y1 | 24 | K1 | 23 |
| | 5 | M1 | 24 | K1 | 23 |
| | 6 | C2 | 24 | K1 | 23 |
| | 7 | C2 | 24 | M2 | 23 |
| | 8 | M3 | 24 | C3 | 23 |
| | 9 | Y2 | 24 | M4 | 23 |
| | 10 | Y2 | 24 | C3 | 23 |
| | 11 | Y2 | 24 | K2 | 23 |
| | 12 | MS | 24 | C1 | 23 |
| | 13 | M6 | 24 | C1 | 23 |
| | 14 | M7 | 24 | C1 | 23 |
| | 15 | M8 | 24 | C1 | 23 |
| | 16 | M9 | 24 | C1 | 23 |
| | 17 | M10 | 24 | C1 | 23 |
| | 18 | M11 | 24 | C1 | 23 |
| | 19 | M12 | 24 | C1 | 23 |
| | 20 | M13 | 24 | C1 | 23 |
| | 21 | M14 | 24 | C1 | 23 |
| | 22 | M15 | 24 | C1 | 23 |
| | 23 | M1 | 24 | C4 | 23 |
| | 24 | M1 | 24 | C5 | 23 |
| | 25 | M1 | 24 | C1 | 23 |
| | 26 | M1 | 24 | C1 | 23 |
| | 27 | M1 | 24 | C1 | 23 |
| | 28 | M1 | 24 | C1 | 23 |
| | 29 | M1 | 24 | C1 | 23 |

TABLE 2-1-2
Evaluation conditions

| | | Evaluation conditions | | | |
|---|---|---|---|---|---|
| | | First ink | | Second ink | |
| | | | Ejection | | Ejection |
| | | Kind | orifice | Kind | orifice |
| | | of ink | array | of ink | array |
| Example | 30 | M1 | 24 | C1 | 23 |
| | 31 | M1 | 24 | C1 | 23 |
| | 32 | M1 | 24 | C1 | 23 |
| | 33 | M1 | 24 | C1 | 22 |
| | 34 | M1 | 24 | C1 | 22 |
| | 35 | M1 | 24 | C1 | 21 |
| | 36 | M16 | 24 | C4 | 21 |
| | 37 | M16 | 24 | C4 | 21 |
| Comparative | 1 | M1 | 24 | C6 | 23 |
| Example | 2 | M1 | 24 | C7 | 23 |
| | 3 | M1 | 24 | C6 | 21 |
| | 4 | M1 | 24 | C6 | 23 |
| | 5 | M1 | 24 | C1 | 23 |
| | 6 | M1 | 24 | C6 | 23 |
| | 7 | M1 | 24 | C7 | 23 |
| Reference | 1 | M1 | — | C6 | — |
| Example | | | | | |

TABLE 2-2-1
Evaluation conditions

| | | Evaluation conditions | | |
|---|---|---|---|---|
| | | Relationship | Relationship | Relationship |
| | | between γs₁ | between η₁ | between S₁ |
| | | and γs₂ | and η₂ | and S₂ |
| Example | 1 | γs₁ < γs₂ | η₁ < η₂ | S₁ > S₂ |
| | 2 | γs₁ < γs₂ | η₁ < η₂ | S₁ > S₂ |
| | 3 | γs₁ < γs₂ | η₁ < η₂ | S₁ > S₂ |
| | 4 | γs₁ < γs₂ | η₁ < η₂ | S₁ > S₂ |
| | 5 | γs₁ < γs₂ | η₁ < η₂ | S₁ > S₂ |
| | 6 | γs₁ < γs₂ | η₁ < η₂ | S₁ > S₂ |
| | 7 | γs₁ < γs₂ | η₁ < η₂ | S₁ > S₂ |
| | 8 | γs₁ < γs₂ | η₁ < η₂ | S₁ > S₂ |
| | 9 | γs₁ < γs₂ | η₁ < η₂ | S₁ > S₂ |
| | 10 | γs₁ < γs₂ | η₁ < η₂ | S₁ > S₂ |
| | 11 | γs₁ < γs₂ | η₁ < η₂ | S₁ > S₂ |
| | 12 | γs₁ < γs₂ | η₁ < η₂ | S₁ > S₂ |
| | 13 | γs₁ < γs₂ | η₁ < η₂ | S₁ > S₂ |
| | 14 | γs₁ < γs₂ | η₁ < η₂ | S₁ > S₂ |
| | 15 | γs₁ < γs₂ | η₁ < η₂ | S₁ > S₂ |
| | 16 | γs₁ < γs₂ | η₁ = η₂ | S₁ > S₂ |
| | 17 | γs₁ < γs₂ | η₁ > η₂ | S₁ > S₂ |
| | 18 | γs₁ < γs₂ | η₁ < η₂ | S₁ > S₂ |
| | 19 | γs₁ < γs₂ | η₁ < η₂ | S₁ > S₂ |
| | 20 | γs₁ < γs₂ | η₁ < η₂ | S₁ > S₂ |
| | 21 | γs₁ < γs₂ | η₁ < η₂ | S₁ > S₂ |
| | 22 | γs₁ < γs₂ | η₁ < η₂ | S₁ > S₂ |
| | 23 | γs₁ < γs₂ | η₁ < η₂ | S₁ = S₂ |
| | 24 | γs₁ < γs₂ | η₁ < η₂ | S₁ < S₂ |
| | 25 | γs₁ < γs₂ | η₁ < η₂ | S₁ > S₂ |
| | 26 | γs₁ < γs₂ | η₁ < η₂ | S₁ > S₂ |
| | 27 | γs₁ < γs₂ | η₁ < η₂ | S₁ > S₂ |
| | 28 | γs₁ < γs₂ | η₁ < η₂ | S₁ > S₂ |
| | 29 | γs₁ < γs₂ | η₁ < η₂ | S₁ > S₂ |

TABLE 2-2-2
Evaluation conditions

| | | Evaluation conditions | | |
|---|---|---|---|---|
| | | Relationship | Relationship | Relationship |
| | | between γs₁ | between η₁ | between S₁ |
| | | and γs₂ | and η₂ | and S₂ |
| Example | 30 | γs₁ < γs₂ | η₁ < η₂ | S₁ > S₂ |
| | 31 | γs₁ < γs₂ | η₁ < η₂ | S₁ > S₂ |
| | 32 | γs₁ < γs₂ | η₁ < η₂ | S₁ > S₂ |
| | 33 | γs₁ < γs₂ | η₁ < η₂ | S₁ > S₂ |
| | 34 | γs₁ < γs₂ | η₁ < η₂ | S₁ > S₂ |
| | 35 | γs₁ < γs₂ | η₁ < η₂ | S₁ > S₂ |
| | 36 | γs₁ < γs₂ | η₁ > η₂ | S₁ < S₂ |
| | 37 | γs₁ < γs₂ | η₁ > η₂ | S₁ < S₂ |
| Comparative | 1 | γs₁ = γs₂ | η₁ < η₂ | S₁ > S₂ |
| Example | 2 | γs₁ > γs₂ | η₁ < η₂ | S₁ > S₂ |
| | 3 | γs₁ = γs₂ | η₁ < η₂ | S₁ > S₂ |
| | 4 | γs₁ = γs₂ | η₁ < η₂ | S₁ > S₂ |
| | 5 | γs₁ < γs₂ | η₁ < η₂ | S₁ > S₂ |
| | 6 | γs₁ = γs₂ | η₁ < η₂ | S₁ > S₂ |
| | 7 | γs₁ > γs₂ | η₁ < η₂ | S₁ > S₂ |
| Reference | 1 | γs₁ = γs₂ | η₁ < η₂ | S₁ > S₂ |
| Example | | | | |

TABLE 2-3-1
Evaluation conditions

| | | Evaluation conditions | | | | | |
|---|---|---|---|---|---|---|---|
| | | Recording head | | | | | |
| | | | | | | Distance | |
| | | Flow step | Flow | | Scanning | between ejection | |
| | | (circulation | speed | Scanning | speed | orifice arrays | Warming |
| | | flow) | (mm/s) | type | (inches/sec) | (mm) | of ink |
| Example | 1 | Present | 10.0 | Serial | 40 | 0.7 | Present |
| | 2 | Present | 10.0 | Serial | 40 | 0.7 | Present |
| | 3 | Present | 10.0 | Serial | 40 | 0.7 | Present |
| | 4 | Present | 10.0 | Serial | 40 | 0.7 | Present |
| | 5 | Present | 10.0 | Serial | 40 | 0.7 | Present |
| | 6 | Present | 10.0 | Serial | 40 | 0.7 | Present |
| | 7 | Present | 10.0 | Serial | 40 | 0.7 | Present |
| | 8 | Present | 10.0 | Serial | 40 | 0.7 | Present |
| | 9 | Present | 10.0 | Serial | 40 | 0.7 | Present |
| | 10 | Present | 10.0 | Serial | 40 | 0.7 | Present |
| | 11 | Present | 10.0 | Serial | 40 | 0.7 | Present |
| | 12 | Present | 10.0 | Serial | 40 | 0.7 | Present |
| | 13 | Present | 10.0 | Serial | 40 | 0.7 | Present |
| | 14 | Present | 10.0 | Serial | 40 | 0.7 | Present |
| | 15 | Present | 10.0 | Serial | 40 | 0.7 | Present |
| | 16 | Present | 10.0 | Serial | 40 | 0.7 | Present |
| | 17 | Present | 10.0 | Serial | 40 | 0.7 | Present |
| | 18 | Present | 10.0 | Serial | 40 | 0.7 | Present |
| | 19 | Present | 10.0 | Serial | 40 | 0.7 | Present |
| | 20 | Present | 10.0 | Serial | 40 | 0.7 | Present |
| | 21 | Present | 10.0 | Serial | 40 | 0.7 | Present |
| | 22 | Present | 10.0 | Serial | 40 | 0.7 | Present |
| | 23 | Present | 10.0 | Serial | 40 | 0.7 | Present |
| | 24 | Present | 10.0 | Serial | 40 | 0.7 | Present |
| | 25 | Present | 10.0 | Serial | 40 | 0.7 | Absent |
| | 26 | Present | 10.0 | Serial | 30 | 0.7 | Present |
| | 27 | Present | 10.0 | Serial | 70 | 0.7 | Present |
| | 28 | Present | 10.0 | Serial | 80 | 0.7 | Present |
| | 29 | Present | 0.5 | Serial | 40 | 0.7 | Present |

TABLE 2-3-2
Evaluation conditions

| | | Evaluation conditions | | | | | |
|---|---|---|---|---|---|---|---|
| | | Recording head | | | | | |
| | | | | | | Distance | |
| | | Flow step | Flow | | Scanning | between ejection | |
| | | (circulation | speed | Scanning | speed | orifice arrays | Warming |
| | | flow) | (mm/s) | type | (inches/sec) | (mm) | of ink |
| Example | 30 | Present | 1.0 | Serial | 40 | 0.7 | Present |
| | 31 | Present | 100.0 | Serial | 40 | 0.7 | Present |
| | 32 | Present | 110.0 | Serial | 40 | 0.7 | Present |
| | 33 | Present | 10.0 | Serial | 40 | 0.1 | Present |
| | 34 | Present | 10.0 | Serial | 40 | 1.8 | Present |
| | 35 | Present | 10.0 | Serial | 40 | 2.5 | Present |
| | 36 | Present | 0.5 | Serial | 80 | 2.5 | Present |
| | 37 | Present | 0.5 | Serial | 80 | 2.5 | Absent |
| Comparative | 1 | Present | 10.0 | Serial | 40 | 0.7 | Present |
| Example | 2 | Present | 10.0 | Serial | 40 | 0.7 | Present |
| | 3 | Present | 10.0 | Serial | 40 | 2.5 | Present |
| | 4 | Present | 10.0 | Serial | 40 | 0.7 | Absent |
| | 5 | Absent | — | Serial | 40 | 0.7 | Present |
| | 6 | Absent | — | Serial | 40 | 0.7 | Present |
| | 7 | Absent | — | Serial | 40 | 0.7 | Present |
| Reference | 1 | Present | 10.0 | Line | — | 0.7 | Present |
| Example | | | | | | | |

TABLE 2-4-1
Evaluation results

| | | Evaluation results | |
|---|---|---|---|
| | | Ruled line | Ejection |
| | | stability | stability |
| Example | 1 | AA | A |
| | 2 | AA | A |
| | 3 | AA | A |
| | 4 | AA | A |
| | 5 | AA | A |
| | 6 | AA | A |
| | 7 | AA | A |
| | 8 | AA | A |
| | 9 | AA | A |
| | 10 | AA | A |
| | 11 | AA | A |
| | 12 | AA | A |
| | 13 | AA | A |
| | 14 | A | A |
| | 15 | AA | A |
| | 16 | A | A |
| | 17 | A | A |
| | 18 | A | A |
| | 19 | AA | A |
| | 20 | AA | A |
| | 21 | AA | A |
| | 22 | AA | A |
| | 23 | A | A |
| | 24 | A | A |
| | 25 | AA | A |
| | 26 | AA | A |
| | 27 | AA | A |
| | 28 | A | A |
| | 29 | AA | B |

TABLE 2-4-2
Evaluation results

| | | Evaluation results | |
|---|---|---|---|
| | | Ruled line | Ejection |
| | | stability | stability |
| Example | 30 | AA | A |
| | 31 | AA | A |
| | 32 | A | A |
| | 33 | AA | A |
| | 34 | AA | A |
| | 35 | AA | A |
| | 36 | B | B |
| | 37 | B | B |
| Comparative | 1 | D | A |
| Example | 2 | D | A |
| | 3 | C | A |
| | 4 | C | A |
| | 5 | AA | C |
| | 6 | AA | C |
| | 7 | AA | C |
| Reference | 1 | AA | A |
| Example | | | |

In the evaluation of the ruled line stability, in each of Comparative Examples 1 to 4, it was visually observed that the position of the ruled line recorded in the forward direction shifted to the home position side with respect to the position of the ruled line recorded in the backward direction. In addition, in all Examples and Comparative Examples, no positional shift occurred between the ruled lines on an opposite side to a home position.

Comparative Examples 5 to 7 are each an example in which the rules lines were recorded under such a condition that the flow step, which was separate from the ejection step, of flowing the ink in the first flow path into the second flow path was not performed. In this case, the flow direction of the ink serving as a reference is not present, and hence the “first” and “second” are not defined for the ejection orifice arrays and the inks. However, for convenience, the ejection orifice arrays and the inks were assigned as shown in Table 2-1-2. It is conceived that, in each of Comparative Examples 5 to 7, the inks were not subjected to circulation flow, and hence even when an image was recorded by reciprocally scanning the recording head, no positional shift between the ruled lines and no variations in their line widths occurred in the end portions of the recording medium. However, the ejection stability was insufficient, and it was required to perform a preliminary ejection operation. Reference Example 1 is an example in which a recording head of a line type corresponding to the width of the recording medium was used as the recording head. It is conceived that, in Reference Example 1, an image was recorded without reciprocally scanning the recording head, and hence no positional shift between the ruled lines and no variations in their line widths occurred in the end portions of the recording medium. In Reference Example 1, the recording head was upsized as compared to the recording head of a serial type, and downsizing of the recording apparatus was not able to be achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-096383, filed Jun. 12, 2023, and Japanese Patent Application No. 2024-079385, filed May 15, 2024, which are hereby incorporated by reference herein in their entirety.

What is claimed is:

1. An ink jet recording method comprising recording an image by ejecting an ink from a recording head including: a plurality of ejection orifices each configured to eject the ink; an ejection element configured to generate energy for ejecting the ink; and a first flow path and a second flow path which communicate to each other between each of the plurality of ejection orifices and the ejection element and inside which the ink flows, the ink jet recording method comprising:
an ejection step of ejecting the ink from the plurality of ejection orifices; and
a flow step, which is separate from the ejection step, of flowing the ink in the first flow path into the second flow path,
wherein the recording head is a recording head of a serial type which includes an ejection element substrate including a plurality of ejection orifice arrays each having the plurality of ejection orifices arranged in a predetermined direction and which is scanned in a direction intersecting with an arrangement direction of the ejection orifice arrays,
wherein the first flow path and the second flow path are arranged in parallel to a scanning direction of the recording head and have the same flow direction of the ink,
wherein the plurality of ejection orifice arrays includes a first ejection orifice array configured to eject a first ink and a second ejection orifice array configured to eject a second ink, and the first ejection orifice array and the second ejection orifice array are arranged on an upstream side and on a downstream side, respectively, with respect to the flow direction of the ink, and
wherein a static surface tension γs₁ of the first ink and a static surface tension γs₂ of the second ink satisfy a relationship of γs₁<γs₂.

2. The ink jet recording method according to claim 1, wherein a dynamic surface tension of the first ink at 10 milliseconds is 36 mN/m or more.

3. The ink jet recording method according to claim 1, wherein a viscosity η₁ of the first ink and a viscosity η₂ of the second ink satisfy a relationship of η₁<η₂.

4. The ink jet recording method according to claim 1, wherein the first ink comprises a compound represented by the following general formula (1): 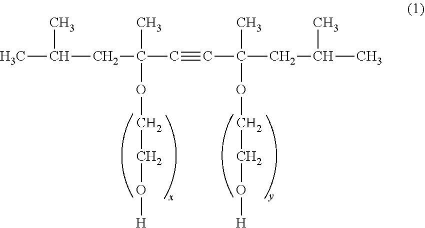
in the general formula (1), “x” and “y” each independently represent a number of 0 or more, and x+y is 0 or more to 50 or less.

5. The ink jet recording method according to claim 1,
wherein the ink comprises a first water-soluble organic solvent having a relative dielectric constant at a temperature of 25° C. of 15.0 or less, and
wherein a ratio S₁ of a content (% by mass) of the first water-soluble organic solvent in the first ink to a total content (% by mass) of water-soluble organic solvents therein and a ratio S₂ of a content (% by mass) of the first water-soluble organic solvent in the second ink to a total content (% by mass) of water-soluble organic solvents therein satisfy a relationship of S₁>S₂.

6. The ink jet recording method according to claim 1, further comprising a step of warming the ink in the recording head.

7. The ink jet recording method according to claim 1, wherein a moving speed of the recording head during the scanning is 70 inches/sec or less.

8. The ink jet recording method according to claim 1, wherein a flow speed of the ink during the flowing is 1.0 mm/s or more to 100.0 mm/s or less.

9. The ink jet recording method according to claim 1, wherein a distance between the first ejection orifice array and the second ejection orifice array is 1.8 mm or less.

10. An ink jet recording apparatus comprising a recording head including: a plurality of ejection orifices each configured to eject the ink; an ejection element configured to generate energy for ejecting the ink; and a first flow path and a second flow path which communicate to each other between each of the plurality of ejection orifices and the ejection element and inside which the ink flows,
the ink jet recording apparatus further comprising a flow unit, which is separate from the ejection element, configured to flow the ink in the first flow path into the second flow path,
wherein the recording head is a recording head of a serial type which includes an ejection element substrate including a plurality of ejection orifice arrays each having the plurality of ejection orifices arranged in a predetermined direction and which is scanned in a direction intersecting with an arrangement direction of the ejection orifice arrays,
wherein the first flow path and the second flow path are arranged in parallel to a scanning direction of the recording head and have the same flow direction of the ink,
wherein the plurality of ejection orifice arrays includes a first ejection orifice array configured to eject a first ink and a second ejection orifice array configured to eject a second ink, and the first ejection orifice array and the second ejection orifice array are arranged on an upstream side and on a downstream side, respectively, with respect to the flow direction of the ink, and
wherein a static surface tension γs₁ of the first ink and a static surface tension γs₂ of the second ink satisfy a relationship of γs₁<γs₂.
